(19) United States
(12) Patent Application Publication
(10) Pub. No.: US 2008/0201156 A1
(43) Pub. Date: Aug. 21, 2008

(54) User-generated community publication in a geo-spatial environment

(75) Inventor: Raj Vasant Abhyanker, Cupertino, CA (US)

Correspondence Address: PILLSBURY WINTHROP SHAW PITTMAN LLP, P.O. BOX 10500, MCLEAN, VA, 22102, US

(73) Assignee: Fatdoor, Inc.

(21) Appl. No.: 11/709,576

(22) Filed: Feb. 21, 2007

(51) Int. Cl. G06Q 30/00

(52) U.S. Cl. 705/1

(57) ABSTRACT

A method, apparatus, and system of a user-generated community publication in a geo-spatial environment are disclosed. In one embodiment, the method includes generating a geo-spatial environment in which residents are represented as users, and in which residents have associated meta-data indicating a physical location and/or an electronic location of the users, processing a user selection of a submit a story idea indicator and/or a become a journalist indicator, processing a submission form when the submit the story idea indicator is selected, and adding a submitted story idea that is geo-tagged to a location identifier of the user to an ideas database, and which remains in the ideas database for a threshold amount of time, transforming a status of a different user to being a community journalist when the different user elects the become the journalist indicator and altering a status of the submitted story idea as being checked out when the community journalist selects the submitted story idea as being one which the community journalist chooses to author.

### FIELD OF TECHNOLOGY

This disclosure relates generally to the technical fields of communications and, in one example embodiment, to a method, apparatus, and system of a user-generated community publication in a geo-spatial environment.

### BACKGROUND

A community publication (e.g., a local newspaper, a city weekly, a school paper, a town crier, a drag car racing magazine, a Russian-American association publication, etc.) may be a publication that focuses its content on topics which are relevant to a focused audience. The focused audience may share traits which are personal in nature (e.g., lifestyle interest, culture, national origin, language, etc.) and/or the focused audience may share traits which are geographic in nature (e.g., live in the same town, city, county, state, etc.). The community publication may be developed around specific topic areas (e.g., news for merchants in a specific industry, fans of particular sports, patrons of the arts, residents of a particular city, participants in the same sorts of lifestyles, etc.)

The community newspaper may hire a community journalist from the focused audience (e.g., so that the community journalist can relate with patrons of the community publication) to keep the community publication relevant to the focused audience. The community journalist may be a civic minded individual who cares about events and happenings in their local neighborhood, and who may desire to contribute and give something back to their neighborhood. The community journalist may volunteer for the community publication and/or work part time for the community publication (e.g., supplemented with a second source of income). The community publication may have an expensive overhead to support the community journalist, in the form of a central office, administrative support, printing equipment, delivery agents, management, and/or advertising professionals.

To get the most interesting stories, the community journalist may solicit story ideas from neighbors, readers and local businesses to stay relevant to the focused audience and to differentiate the community publication from other community newspapers. For example, a reader may submit a story idea to the community publication (e.g., through a letter to an editor) with a desire to be recognized for an event and/or observation in their life (e.g., 250 pound pumpkin, bumper crop of cherries, grand opening bargains, wedding, graduation, obituary, sports award, etc.). The community journalist may manually screen interesting stories after receiving them from the administrative support, and physically interview the reader by scheduling a time to meet over the phone.

In addition, to stay profitable, the community publication may seek advertising from local businesses. However, the community publication may be faced with increased competition from the Internet (e.g., Craigslist®, Google®, etc.) for advertising (e.g., for jobs, real estate, cars, personal ads, etc.), and for available leisure time to read the community publication.

### SUMMARY

A method, apparatus and system of a user-generated community publication in a geo-spatial environment. In one aspect the method includes generating a geo-spatial environment in which residents are represented as users, and in which residents have associated meta-data indicating a physical location and/or an electronic location of the users, processing a user selection of a submit a story idea indicator and/or a become a journalist indicator, processing a submission form when the submit the story idea indicator is selected, and adding a submitted story idea (e.g., the story idea is a personals listing data, a wedding announcement data, a classifieds advertisement data, a residential news data, a local sports data, a funnies data, a game data, a marketed property listing data, a crime statistics data, an events data, an obituary data, a polling data, a calendar data, a horoscopes data, and/or a freebees data) that is geo-tagged to a location identifier of the user to an ideas database, and which remains in the ideas database for a threshold amount of time, transforming a status of a different user to being a community journalist when the different user elects the become the journalist indicator and altering a status of the submitted story idea as being checked out when the community journalist selects the submitted story idea as being one which the community journalist chooses to author.

The method may also include determining a timer for a duration of a checked out status of the submitted story idea, and resetting the timer when the community journalist authors an article based on the submitted story idea and submits the article to a journalism module. The method may further include automatically determining a continuing qualification of the community journalist based on responses to the timer, and/or a peer feedback rating and/or a reader feedback rating of the article authored by the community journalist. Moreover, the method may include providing a consideration to the community journalist in a form of a monetary award, a salary, and/or a recognition point based on the peer feedback rating, a number of reader page views, the reader feedback, and/or an advertising revenue generated based on geo-spatially targeted advertisements adjacent to the article and/or a community publication.

Furthermore, the method may include automatically generating the community publication (e.g., the community publication may be generated to a group based on a geographic location of the group, a common professional interests of the group, a religious affiliation of the group, a friendship between members of the group, an educational institution associated with the group, a cultural affiliation of the group, a political interest of the group, and/or a social interest of the group) based on the article and other articles submitted by other community journalists at a periodically occurring interval, publishing the community publication in the geospatial environment to targeted users distributable to the electronic location of a subset of the targeted users subscribing to the community publication when the electronic location is available and/or creating a postal mailing of the community publication to another subset of the targeted users (e.g., the another subset of the targeted users may have a self declared subscription to the community publication and/or which are targeted as being possibly interested in the community publication) based on a mailing to the physical location of the targeted users.

Additionally, the method may include automatically generating the community publication in any of a selectable number of languages that may be based on readership preferences of the members of the group and/or a moderator user who may serve as an editor and/or publisher of the community publication in the geo-spatial environment, embedding in the name of the community publication a name of an operator of the geo-spatial environment and automatically repositioning the article in an electronic version of the community publication based on a popularity of the article as elected by readers of the article (e.g., each reader of the community publication can vote on the submitted story ideas for publication consideration in a future community publication based on a popularity of any particular submitted story idea with readers) in the electronic version of the community publication.

The method may also include providing a mobile application (e.g., the mobile application is location aware based on a global positioning data provided in the mobile device embodying the mobile application and in which the community journalist does not have to indicate a current location of a journalist when navigating to a location of interest) to the community journalist to capture and/or record in video, audio, and text form an interview which may be based on the submitted story idea, and/or to annotate text of the interview automatically in a mobile device.

Further, the method may also include automatically generating a representation of neighbors and/or businesses surrounding a location of the community journalist and/or simultaneously providing access to a wiki data provided by users in locations surrounding and/or including the location of interest and/or a present location of the community journalist in a three-dimensional visual neighborhood view. The method may also include a machine-readable medium embodying a set of instructions that, when executed by a machine, causes the machine to perform any of the methods disclosed herein.

In another aspect, a method includes generating a set of story ideas which are submitted by users of a geo-spatial social network and which are grouped based on a meta-data identifying a social, a geographic, and/or an interest based characteristic of the users which submit the set of story ideas, allocating at least one of the story ideas to a different user who has elected to be a community journalist in the geo-spatial social network, and/or, in response to an article submission by the community journalist, automatically formatting and/or screening relevant content when approved by a community editor, generating a community publication based on the relevant content submitted by the community journalist, other community journalists, and/or a user generated content data that includes an announcement data, a classifieds data, a user generated games data, and/or a personals data submitted by users who have joined a group which associates and/or subscribes them to the community publication, and/or distributing the community publication to subscribed individuals through a direct mail and/or an electronic communication based on a circulation criteria as defined by a moderator of the community publication in a geo-spatial environment.

The method may also include providing a consideration to the community journalist in a form of a monetary award, a salary, and/or a recognition point based on a peer rating feedback, a number of reader page views, a reader feedback, (e.g., each reader of the community publication can vote on submitted story ideas for publication consideration in a future community publication based on a popularity of any particular submitted story idea with readers) and/or an advertising revenue generated based on geo-spatially targeted advertisements adjacent to the article and/or the community publication.

The method may further include providing a mobile application (e.g., the mobile application is location aware based on a global positioning data provided in the mobile device embodying the mobile application and in which the community journalist does not have to indicate a current location of the journalist when navigating to a location of interest) to the community journalist to capture and/or record in video, audio, and/or text form an interview based on the submitted story idea, and/or to annotate text of the interview automatically in a mobile device.

In yet another aspect a system includes a publishing module to create a user generated content having relevant news to a geo-spatially meta-tagged community at a predefined frequency, a writing tools module to enable some of users of a geospatial environment to elect stories they wish to write articles on and a distribution module to automatically distribute to the user generated content to a members of a group associated with a target demographic associated with the user generated content by associating a meta-data associated with the members of the group with a physical postal address and automatically generating a community publication to distribute to the group.

The system may also include an ideas module to manage a set of user-generate ideas of a reader group of the community publication and/or to organize submitted ideas such that the submitted ideas conform to a predetermined set of templates which may identify a structured data in which the ideas may become submittable for consideration in a future community publication, and in which the predetermined templates may include a news template, an announcement template, an obituary template, a sports template, a calendar template, a games template, a poll template, a crime data template, a real estate for sale template, an advertising template, and/or a personals template.

The system may further include a profit share module to allocate profits from revenues of classified and/or display advertisements in the community publication with authors or articles of the community publication, community journalists, an editor, idea submitters, and/or others who have submitted user generated content in the community publication to provide incentive providing future relevant and/or timely content in future community publications.

The methods, systems, and apparatuses disclosed herein may be implemented in any means for achieving various aspects, and may be executed in a form of a machine-readable medium embodying a set of instructions that, when executed by a machine, cause the machine to perform of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a geo-spatial environment communicating with the advertising module, distribution module and the publishing module, according to one embodiment.

FIG. 2 is a user interface view of a community publication, according to one embodiment.

FIG. 3 is a device view of a mobile device, according to one embodiment.

FIG. 4 is a list view of a summary, according to one embodiment.

FIG. 5 is a system view of the geo-spatial environment communicating with the client device through a network, according to one embodiment.

FIG. 6 is a diagrammatic system view of a data processing system in which any of the embodiments disclosed herein may be performed, according to one embodiment.

FIG. 7 is a table view of information related to a user, according to one embodiment.

FIG. 8 is an exploded view of a user tagging module of FIG. 1, according to one embodiment.

FIG. 9 is an exploded view of an ideas module of FIG. 1, according to one embodiment.

FIG. 10 is an exploded view of a writing tools module of FIG. 1, according to one embodiment.

FIG. 11 is an exploded view of a publishing module of FIG. 1, according to one embodiment.

FIG. 12 is an exploded view of an advertising module of FIG. 1, according to one embodiment.

FIG. 13 is an exploded view of a distribution module interacting with the geo-spatial environment and the post office, according to one embodiment.

FIG. 14 is a user interface view of tagging module, according to one embodiment.

FIG. 15 is a user interface view of ideas module, according to one embodiment.

FIG. 16 is a user interface view of writing tools module, according to one embodiment.

FIG. 17 is a user interface view of distributing an article in a geospatial environment, according to one embodiment.

FIG. 18 is a user interface view of group module, according to one embodiment.

FIG. 19 is a user interface view of distribution among the users, according to one embodiment.

FIG. 20A is a process submitting story idea in the created geo-spatial environment, according to one embodiment.

FIG. 20B is a continuation of process flow of FIG. 20B showing additional processes, according to one embodiment.

FIG. 20C is a continuation of process flow of FIG. 20C showing additional processes, according to one embodiment.

FIG. 21A is a process flow of generating, submitting and publishing the content in the geo-spatial environment, according to one embodiment.

FIG. 21B is a continuation of process flow of FIG. 21A showing additional processes, according to one embodiment.

Other features of the present embodiments will be apparent from the accompanying drawings and from the detailed description that follows.

### DETAILED DESCRIPTION

A method, apparatus and system of a user-generated community publication in a geo-spatial environment are disclosed. In the following description, for the purposes of explanation, numerous specific details are set forth in order to provide a thorough understanding of the various embodiments. It will be evident, however to one skilled in the art that the various embodiments may be practiced without these specific details.

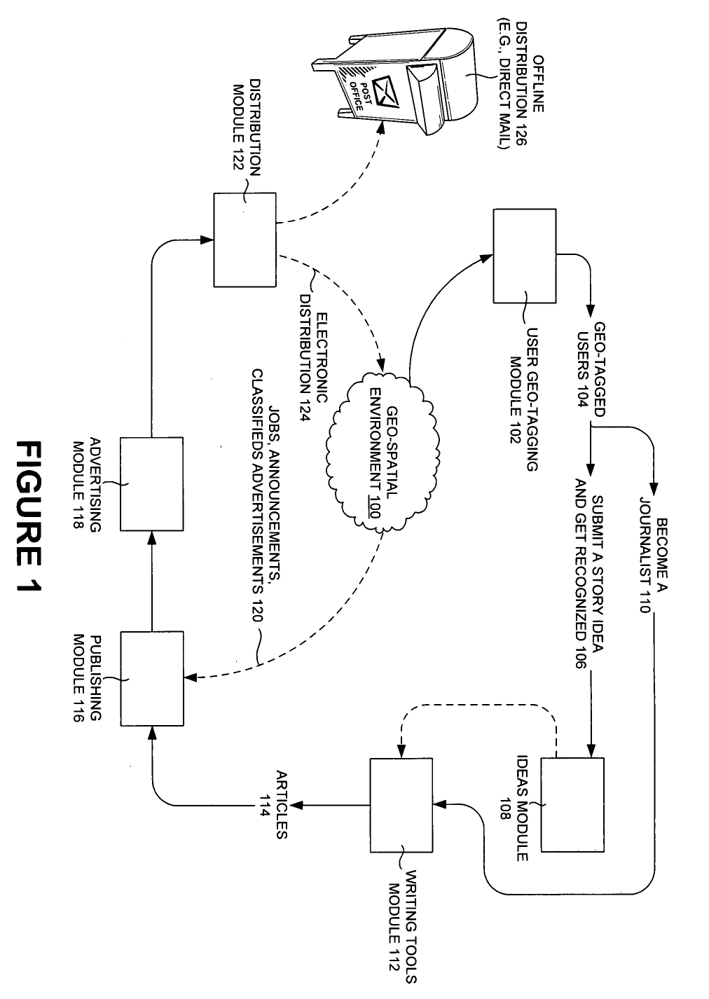

In one embodiment, a method includes generating a geo-spatial environment in which residents are represented as users, and in which residents have associated meta-data indicating a physical location and/or an electronic location of the users, processing a user selection of a submit a story idea indicator and/or a become a journalist indicator, processing a submission form when the submit the story idea indicator is selected, and adding a submitted story idea that is geo-tagged to a location identifier of the user to an ideas database, and which remains in the ideas database for a threshold amount of time, transforming a status of a different user to being a community journalist when the different user elects the become the journalist indicator, and altering a status of the submitted story idea as being checked out when the community journalist selects the submitted story idea as being one which the community journalist chooses to author (e.g., as described in FIGS. 1-21).

In another embodiment, a method includes generating a set of story ideas which submitted by users of a geo-spatial social network and which are grouped based on a meta-data identifying a social, a geographic, and/or an interest based characteristic of the users which submit the set of story ideas, allocating at least one of the story ideas to a different user who has elected to be a community journalist in the geo-spatial social network, and, in response to an article submission by the community journalist, automatically formatting and screening relevant content when approved by a community editor, generating a community publication based on the relevant content submitted by the community journalist, other community journalists, and a user generated content data that includes an announcement data, a classifieds data, a user generated games data, and a personals data submitted by users who have joined a group which associates and subscribes them to the community publication and distributing the community publication to subscribed individuals through a direct mail and/or an electronic communication based on a circulation criteria as defined by a moderator of the community publication in a geo-spatial environment (e.g., as described in FIGS. 1-21).

In yet another embodiment, a system includes a publishing module to create a user generated content having relevant news to a geo-spatially meta-tagged community at a predefined frequency, a writing tools module to enable some of users of a geospatial environment to elect stories they wish to write articles on and a distribution module to automatically distribute to the user generated content to a members of a group associated with a target demographic associated with the user generated content by associating a meta-data associated with the members of the group with a physical postal address and automatically generating a community publication to distribute to the group (e.g., as described in FIGS. 1-21).

FIG. 1 is a system view of a geo-spatial environment 100 communicating with an advertising module 118, a distribution module 122 and a publishing module 116, according to one embodiment. Particularly FIG. 1 illustrates the geo-spatial environment 100, a user geo-tagging module 102, a geo-tagged users 104, a submit a story idea and get recognized 106, a ideas module 108, a become a journalist 110, a writing tools module 112, an articles 114, a publishing module 116, the advertising module 118, a jobs, announcements, classifieds, advertisements 120, the distribution module 122, an electronic distribution 124 and an offline distribution 126, according to one embodiment. The geo-spatial environment 100 may be a combination of spatial software and analytical methods with terrestrial and/or geographic datasets.

The user geo-tagging module 102 may enable the user to provide geographical identification regarding specific places and/or information that may be based on latitude, longitude and/or altitude. The geo-tagged users 104 may enable the user to link geographical identification with different media in the geo spatial environment. The submit a story idea and get recognized 106 link may facilitate the entities to propose the story in the geo-spatial environment and/or get acknowledged when the story is liked/found interesting by other users.

The ideas module 108 may enable the users to list their plans, stories, and/or ideas online in a geo-spatial environment. The become a journalist 110 link may enable a user to change a state of their profile as being a contributor of an article or writing and interviewing users who have submitted story ideas in the community publication. For example, users who have become journalists may see all or a portion of the articles submitted by readers of the community publication. As such, the system may be a peer community publication in which readers themselves may elect to become journalists and perhaps even get paid a little bit to write articles. In other words, the community publication can be created within a group, by a moderator of a group, such that the users can of the group can generate their own story ideas and become writers (e.g., journalists) in the community publication. The journalist users may gather and disseminate information about current events, trends, issues and people after interviewing those members of a group who have submitted a story idea. The writing tools module 112 may facilitate the users to write their information, stories, plans, actions and/or action dates online in a geo-spatial environment. The articles 114 may be a piece of prose that may be an independent part of a publication and/or proposed by the user. The publishing module 116 may enable the users to produce, distribute and/or disseminate available information, stories, plans, actions and/or action dates online.

The advertising module 118 may enable publicity, public relations, product placement, sponsorship, underwriting and/or sales promotion in the geo-spatial environment. The jobs, announcements, classifieds, advertisements 120 may allow the entities to post and/or receive any information associated with jobs, announcements, classifieds, advertisements. The distribution module 122 may enable the user to spread, disperse, consign, sell, barter, offer for sale, solicit, circulate, give out and/or otherwise deal with the product and/or information in a geo-spatial environment. The electronic distribution 124 may enable the practice of allowing entities to download the products electronically. The offline distribution 126 may enable the user to distribute information through media (e.g. direct mail).

In an example embodiment as illustrated in FIG. 1, the geo-spatial environment 100 communicates with the advertising module 118, the distribution module 122 and the publishing module 116. The distribution module 122 interacts with the offline distribution 126. The advertising module 118 communicates with the ideas module 108 through the geo-tagged users 104 and become a journalist 110 and also the advertising module 118 communicates with the writing tools module 112 through the geo-tagged users 104 and become a submit a story idea and get recognized 106. The writing tools module 112 may communicate with the publishing module 116 through the articles 114. The publishing module communicates with the distribution module 122 through advertising module 118.

For example the geo-spatial environment in which residents are represented as users may be generated, and/or in which residents have associated meta-data indicating a physical location and/or an electronic location of the user. The user selection a submit a story idea and/or a become a journalist indicator may be processed. The submission form may be processed when the submit the story idea indicator is selected, and/or the submitted story idea may be added that is geo-tagged to a location identifier of the user to an ideas database, and/or which remains in the ideas database for a threshold amount of time. The community publication may be distributed to subscribed individuals through a direct mail and/or an electronic communication (e.g., the offline distribution 126 of FIG. 1) based on a circulation criteria as defined by a moderator of the community publication in a geo-spatial environment.

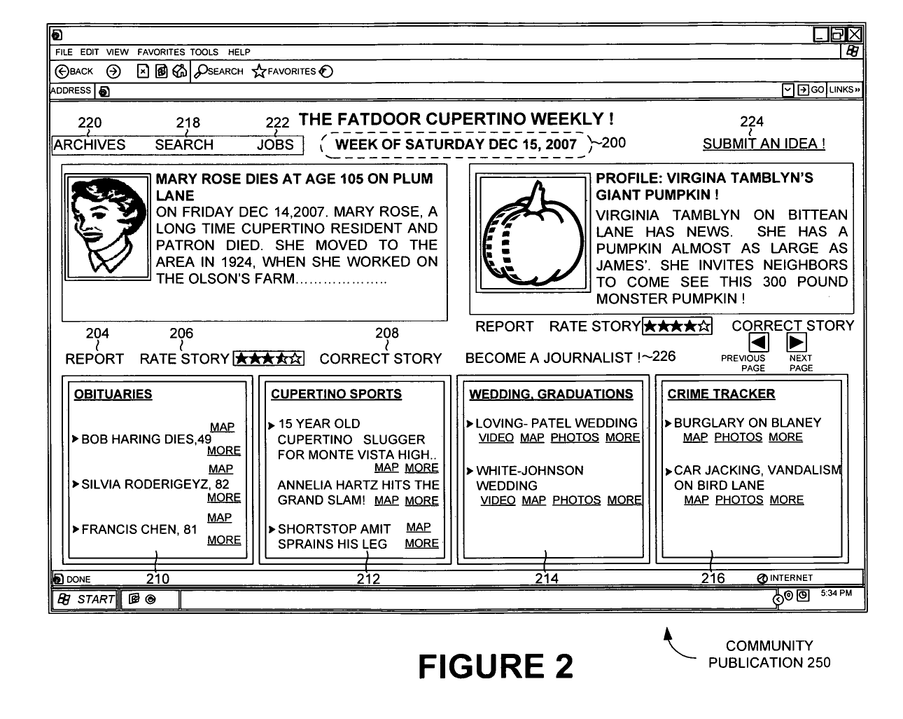

FIG. 2 is a user interface view of a community publication 250, according to one embodiment. The user interface view may provide the user with information regarding the weekly updates. The option 200, may provide information of a particular day and/or date to the user. For example the events for that particular day Saturday and/or date 15 Dec. 2007. The report option 204, may be a public and/or private, and/or often address questions posed by individuals in a government, a business, a education, and/or a science. The rate story 206 option may be a rating process rated by other users where the stories may be rated for example by giving stars. The search option 218 may be to thoroughly examine in order to find something concealed and/or an online search engine may be any device that allows the user to quickly search and/or view multiple online articles/websites.

The archives option 220 are made up of records which have been created during the course of an individual and/or organization's life and/or it may consists of records which have been selected for permanent and/or long-term preservation. The jobs option 222 may refer to a piece of work and/or a task. Specifically, it may refer to the activity of economic production, employment and/or labor. The submit an idea option 224, may provide the user to propose a thought, a design, a plan, a scheme and/or an inspiration. The become a journalist option 226 may be an opportunity in which the user may become a journalist.

For example the set of story ideas which submitted by users of a geo-spatial social network and/or which are grouped based on a meta-data identifying at least one of a social, a geographic, and an interest based characteristic of the users which submit the set of story ideas may be generated. A consideration to the community journalist may be provided in a form of at least one of a monetary award, a salary, and a recognition point based on at least one of the peer rating feedback, a number of reader page views, the reader feedback, and an advertising revenue generated based on geo-spatially targeted advertisements adjacent to at least one of the article and a community publication.

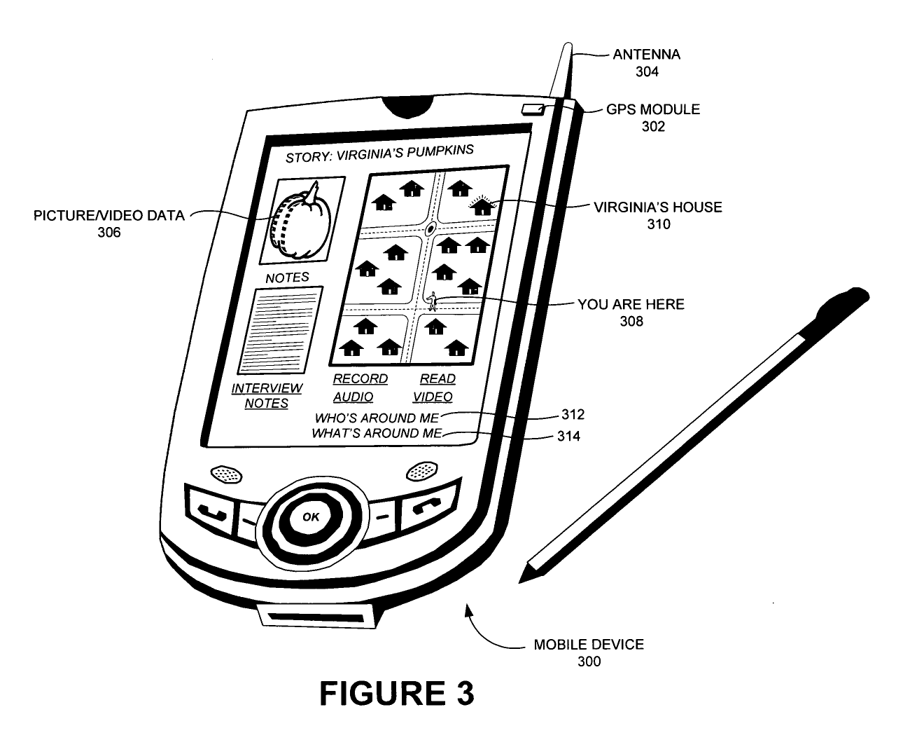

FIG. 3 is a device view of a mobile device 300, according to one embodiment. Particularly FIG. 3 illustrates a GPS module 302, an antenna 304, a picture/video data 306, you are here 308, virginia's house 310, who's around me 312 and what's around me 312 according to one embodiment. The mobile device 300 may be a pocket-sized computing device, typically utilizing a small visual display screen for user output and a miniaturized keyboard for user input. The input and output may be combined into a touch-screen interface. The GPS module 302 may be a fully-functional satellite navigation system which may transmit signals allowing GPS receivers to determine the receiver's location, speed and/or direction.

The antenna 304 may be a component designed to send and receive signals in a mobile device associated with the user. The picture/video data 306 may be a data which may be captured, recorded, processed, stored, transmitted and restructured in a sequence of still images which may represent scenes in motion in the mobile device. The you are here 308 may be a feature in the mobile device for navigation and locating the entities location. The virginia's house 310 may be a display of a particular place which is being navigated. The who's around me 312 may be a feature in the mobile device 300 which may provide information about the people in a particular geographic location around the user. The what's around me 314 may be a feature in the mobile device 300 which may provide information about the places in a particular geographic location surrounding the users.

For example, a mobile application may be provided to the community journalist to capture and record in video, audio, and text form an interview based on the submitted story idea, and to annotate text of the interview automatically in the mobile device. The mobile application is location aware based on a global positioning data provided in a mobile device embodying the mobile application and in which the community journalist does not have to indicate a current location of the journalist when navigating to a location of interest.

A mobile application may be provided to the community journalist to capture and record in video, audio, and text form an interview based on a submitted story idea, and to annotate text of an interview automatically in the mobile device, and wherein the mobile application is location aware based on a global positioning data provided in a mobile device embodying the mobile application and in which the community journalist does not have to indicate a current location of the journalist when navigating to a location of interest. A representation of neighbors and businesses surrounding a location of the community journalist and simultaneously providing access to a wiki data provided by users in locations surrounding and including the location of interest and a present location of the community journalist in a three-dimensional visual neighborhood view may be automatically generated.

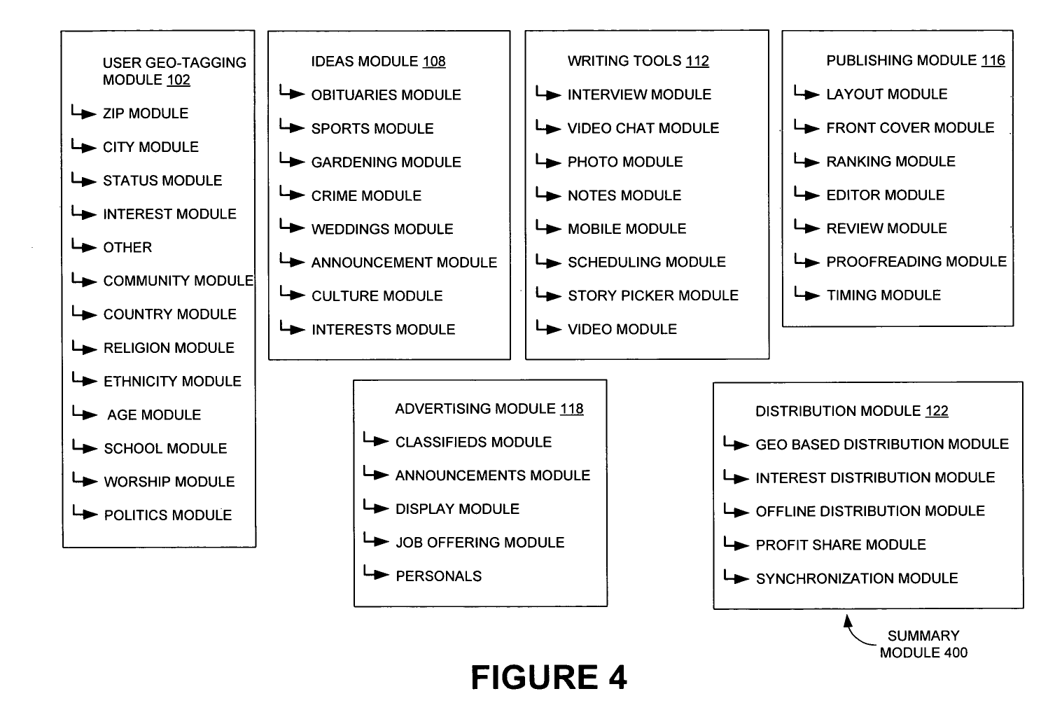

FIG. 4 is a list view of a summary 400, according to one embodiment. Particularly FIG. 4 illustrates the user geo-tagging module 102, the ideas module 108, the writing tools module 112, the publishing module 116, the advertising module 118 and a distribution module 122 in one embodiment and a summary 400. The user geo-tagging module 102 may enable the users to find a variety of location specific information which may be based on latitude, longitude and/or altitude. The ideas module 108 may enable the users to list their plans, stories and/or ideas online in a geo-spatial environment.

The writing tools module 112 may facilitate the users to write their information, stories, plans, actions and/or action dates online in a geo-spatial environment. The publishing module 116 may enable the users to produce, distribute and/or disseminate available information, stories, plans, actions and/or action dates online. The advertising module 118 may enable publicity, public relations, product placement, sponsorship, underwriting and/or sales promotion in the geo-spatial environment. The distribution module 122 may enable the user to spread, disperse, consign, sell, barter, offer for sale, solicit, circulate, give out and/or otherwise deal with the product and/or information in a geo-spatial environment.

In the example embodiment as illustrated in FIG. 4, the user geo-tagging module 102 may include a zip module, a city module, a state module, an interest module, an other module, a country module, a religion module, an ethnicity module, an age module, a school module, a neighbor module and/or a politics module. The ideas module 108 may include obituaries module, a sports module, a gardening module, a crime module, a weddings module, an announcements module, a culture module and/or an interests module.

The writing tools modules 112 may include interview module, video chat module, a photo module, a notes module, a mobile module, scheduling module, a story picker module and/or a video module. The publishing module 116 may include layout module, front cover module, rankings module, editor module, review module, proofreading module and/or timing module. The advertising module 118 may include a classifieds module an announcements module, a display module, a job offering module and/or a personal. The distribution module 122 may include a geo based distribution module, an interest distribution module, an offline distribution module, a profit share module, and a synchronization module.

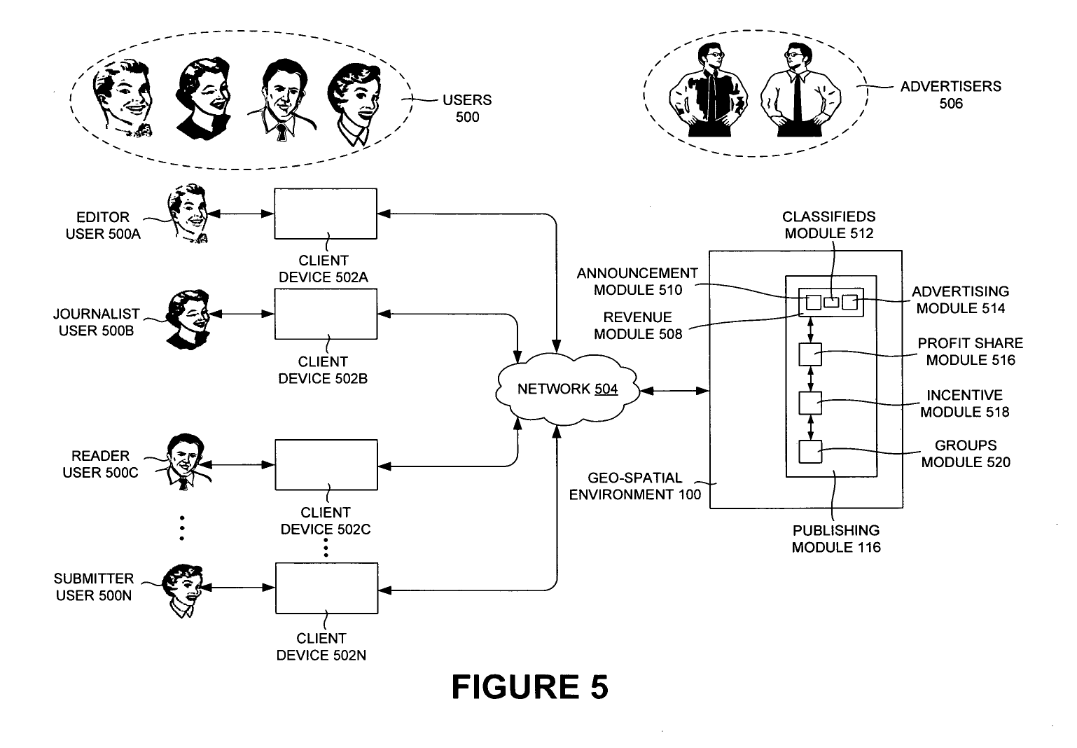

FIG. 5 is a system view of the geo-spatial environment 100 communicating with the client device 502A-N through a network 504, according to one embodiment. Particularly, FIG. 5 illustrates the geo-spatial environment 100, the publishing module 116, a users 500, an editor user 500 A, a journalist user 500 B, a reader user 500 C, a submitter user 500 N, the client device 502 A, 502 B, 502 C, 502 N, a network 504, an advertisers 506, a revenue module 508, an announcement module 510, a classifieds module 512, an advertising module 514, a profit share module 516, an incentive module 518 and a groups module 520.

The users 500 may be at least one of the editor user 500 A, the journalist user 500 B, the reader user 500 C, the submitter user 500 N contributing to the geospatial environment. The editor user 500 A may edit the contents (e.g. the news, the articles, the story, the jokes, etc.) in the markup page. The journalist user 500B may collect the information from different regions and may post contents (e.g. the news, the articles, the story etc.) providing the other users to view the same. The submitter user 500 N may submit the stories, ideas and/or information on the relevant markup page for the other user. The reader user 500 C may be the person who utilizes the contents on the markup page.

The client device 502 A-N may be any device which display the contents and enable the user to access the information in the geo-spatial environment (e.g., a desktop, a laptop, a mobile phone etc.). The network 504 may allow the users to get inter connected to each other and access the information through the markup page. The advertisers 506 may involve in sponsorship by advertising their new products and/or services on the network. The publishing module 116 may be associated with the publication of any of the contents (e.g., an advertisement, a classifieds etc.) on the markup page. The revenue module 508 may update the amount of money that the entity earns from its activities in a given period mostly from sales of products and/or services to customers.

The announcement module 510 may announce the forthcoming events (e.g., an auction, sale, a scheduled events, a launch of new products and/or services etc.) to the user of the geo-spatial environment. The classifieds module 512 may be associated with advertisements that are grouped under different classifications of the product or service being offered (headings such as accounting, automobiles, clothing, jobs, auction, farm produce, for sale, for rent, etc.). The advertising module 514 may advertise the products and/or services of the entities on the markup page. The profit share module 516 may refer to various incentive plans introduced by businesses that provide direct or indirect payments to user that depend on entity profitability.

The incentive module 518 may provide a motive for a particular course of action, or counts as a reason for preferring one choice to the alternatives. The groups module 520 may allow the user to find groups related to their interests and participate in threaded conversations in the geo-spatial environment may be by posting to the group through the groups web interface.

In an example embodiment as illustrated in FIG. 5, the geo-spatial environment 100 communicates with the client device 502A-N through the network 504. The client devices 502A-N communicates with the editor user 500 A, the journalist user 500 B, the reader user 500 C and the submitter user 500 N. The geo-spatial environment 100 may include the publishing module 116. The revenue module 508 of the publishing module 116 may communicate with the groups module 520 through the profit share module 516, the incentive module 518.

For example the geo-spatial environment in which residents are represented as users may be generated, and/or in which residents have associated meta-data indicating a physical location and/or an electronic location of the user. The set of user-generate ideas of a reader group of the community publication may be managed by the ideas module and/or the submitted ideas may be organized such that the submitted ideas conform one of a predetermined set of templates which identify a structured data in which the ideas become submittable for consideration in a future community publication, and/or in which the predetermined templates include at least one of a news template, an announcement template, an obituary template, a sports template, a calendar template, a games template, a poll template, a crime data template, a real estate for sale template, an advertising template, and/or a personals template.

The geo-spatial environment (e.g., the geo-spatial environment 100 of FIG. 1) may be generated in which residents are represented as users, and in which residents have associated meta-data indicating at least one of a physical location and an electronic location of the users. The name of the community publication a name of an operator of the geo-spatial environment may be embedded. A representation of neighbors and businesses surrounding a location of the community journalist and simultaneously providing access to a wiki data provided by users in locations surrounding and including the location of interest and a present location of the community journalist in a three-dimensional visual neighborhood view may be automatically generated,

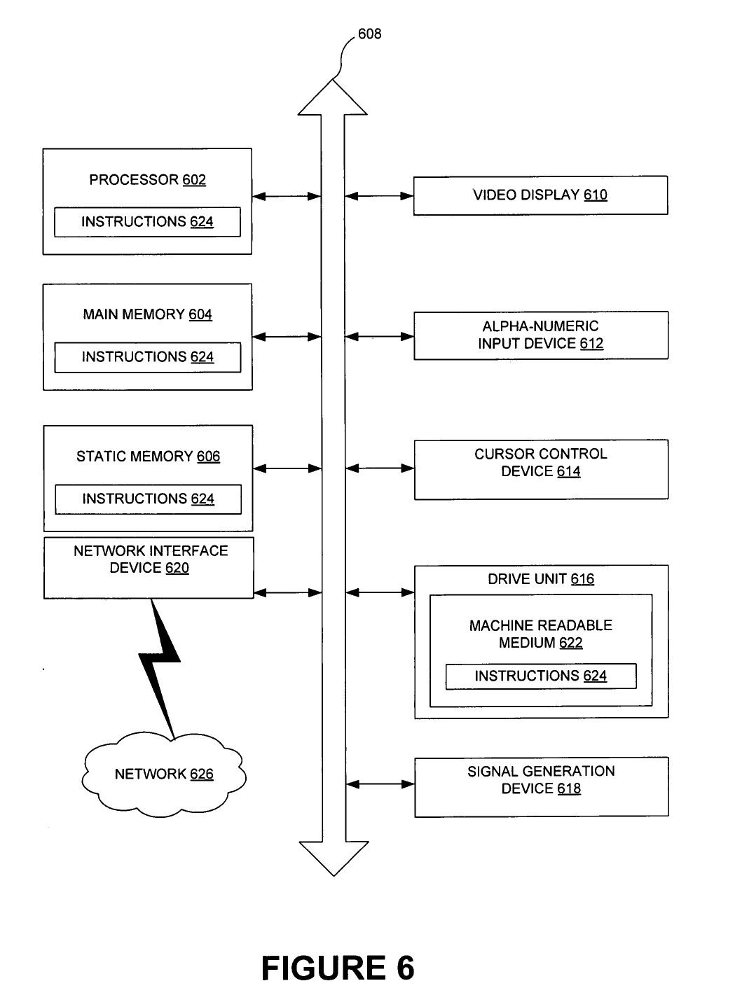

FIG. 6 is a diagrammatic system view of a data processing system in which any of the embodiments disclosed herein may be performed, according to one embodiment. Particularly, the system view 600 of FIG. 6 illustrates a processor 602, a main memory 604, a static memory 606, a bus 608, a video display 610, an alpha-numeric input device 612, a cursor control device 614, a drive unit 616, a signal generation device 618, a network interface device 620, a machine readable medium 622, instructions 624, and a network 626, according to one embodiment.

The diagrammatic system view 600 may indicate a personal computer and/or a data processing system in which one or more operations disclosed herein are performed. The processor 602 may be microprocessor, a state machine, an application specific integrated circuit, a field programmable gate array, etc. (e.g., Intel® Pentium® processor). The main memory 604 may be a dynamic random access memory and/or a primary memory of a computer system. The static memory 606 may be a hard drive, a flash drive, and/or other memory information associated with the data processing system.

The bus 608 may be an interconnection between various circuits and/or structures of the data processing system. The video display 610 may provide graphical representation of information on the data processing system. The alpha-numeric input device 612 may be a keypad, keyboard and/or any other input device of text (e.g., a special device to aid the physically handicapped). The cursor control device 614 may be a pointing device such as a mouse.

The drive unit 616 may be a hard drive, a storage system, and/or other longer term storage subsystem. The signal generation device 618 may be a bios and/or a functional operating system of the data processing system. The network interface device 620 may be a device that may perform interface functions such as code conversion, protocol conversion and/or buffering required for communication to and from a network (e.g., the network 504, 626 of FIG. 5-6). The machine readable medium 622 may provide instructions on which any of the methods disclosed herein may be performed. The instructions 624 may provide source code and/or data code to the processor 602 to enable any one/or more operations disclosed herein.

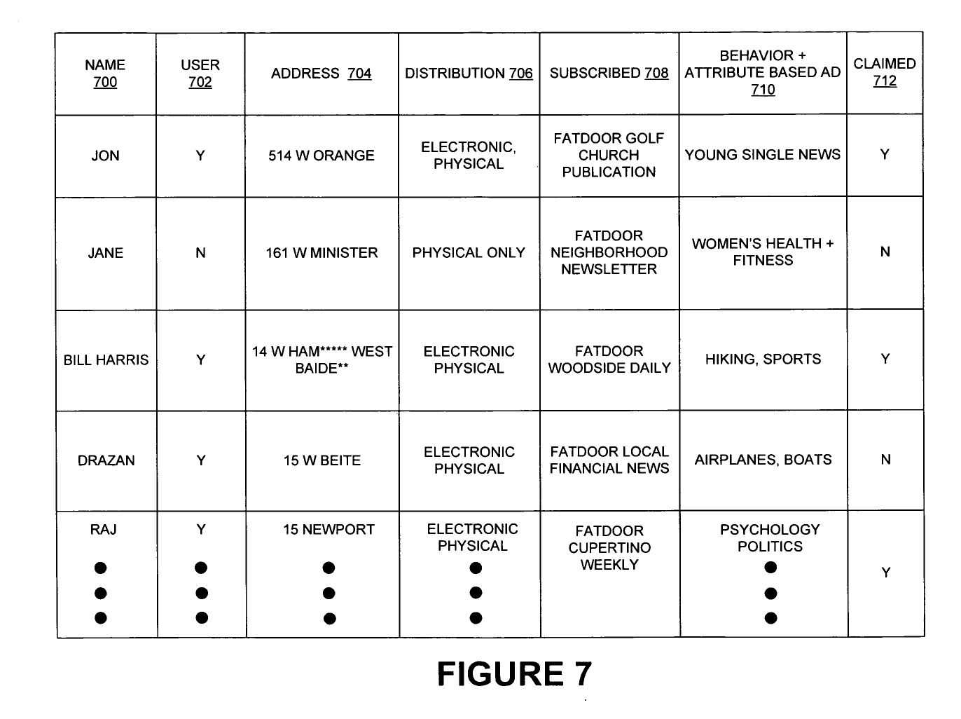

FIG. 7 is a table view of information related to a user, according to one embodiment. Particularly FIG. 7 illustrates various fields such as a name 700, a user 702, an address 704, a distribution 706, a subscribed 708, a behavior+attribute based ad 710, and a claimed 712. The name 700 may list the names of the entities using the account in the geo-spatial environment. The user 702 may pop up the status of the entities as users or non users. The address 704 may show the place where an entity may be found and/or communicated with in the geo spatial environment.

The distribution 706 may show forms of distributing (e.g. electronic, physical, etc.) information to the entities. The subscribed 708 may show the status of the subscription the entity may have (e.g., fatdoor golf, church publication, etc.). The behavior+attribute based ad may show the interest and characteristics of the entity. The claimed 712 may show the status of profile whether claimed or not.

For example the user Jon may reside at 514 W Orange with electronic and physical distribution and may be subscribed to the fatdoor golf and church publication who may be interested in young and/or single news and who may have claimed his profile. In yet another example Jane may not be a user who may be contacted at 161, West Minister having only physical distribution and who may be subscribed to fatdoor neighborhood newsletter and who may be interested in woman's health and fitness, who may have not claimed her profile.

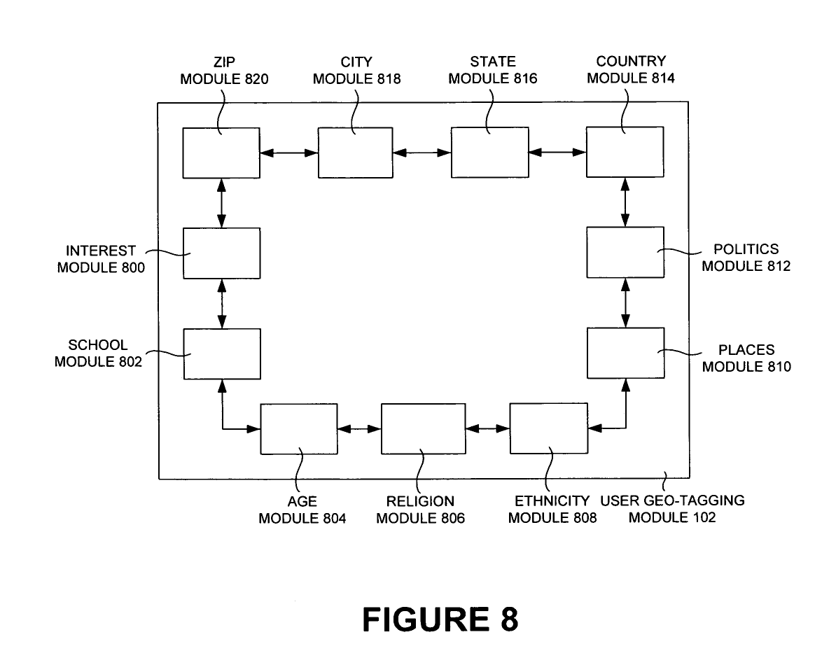

FIG. 8 is an exploded view of a user geo-tagging module 102 of FIG. 1, according to one embodiment. Particularly, FIG. 8 illustrates an interest module 800, a school module 802, an age module 804, a religion module 806, an ethnicity module 808, a places module 810, a politics module 812, a country module 814, a state module 816, a city module 818 and a ZIP module 820, according to one embodiment.

The interest module 800 may provide the user with information like peoples interest (e.g., sports, club activities, hobbies, etc). The school module 802 may allow the user to get information associated to the schools in a particular geo-spatial environment. The age module 804 may provide age information to the users of the desired people who live in the geo-spatial environment. The religion module 806 may allow the user to get information about the community of the users in the particular geo-spatial environment. The ethnicity module 808 may update information about the common cultural, behavioral, linguistic and ritualistic or religious traits of the users in the particular geo-spatial environment.

The places module 810 may give information about the places in the particular geo-spatial environment. The politics module 812 may provide information associated with politics like the ruling, un-ruling parties etc in the geo-spatial environment. The country module 814, the state module 816, the city module 818 and the ZIP module 820 may give the information of the place where the users reside in the geo-spatial environment.

In an example embodiment as illustrated in FIG. 8, the interest module 800 may communicate with the school module 802 and zip module 820. The age module 804 may communicate with the school module 802 and places module 810 through the religion module 806 and the ethnicity module 808. The politics module 812 may communicate with the state module 816 through the country module 814. the city module 818 may communicate with the zip module 820.

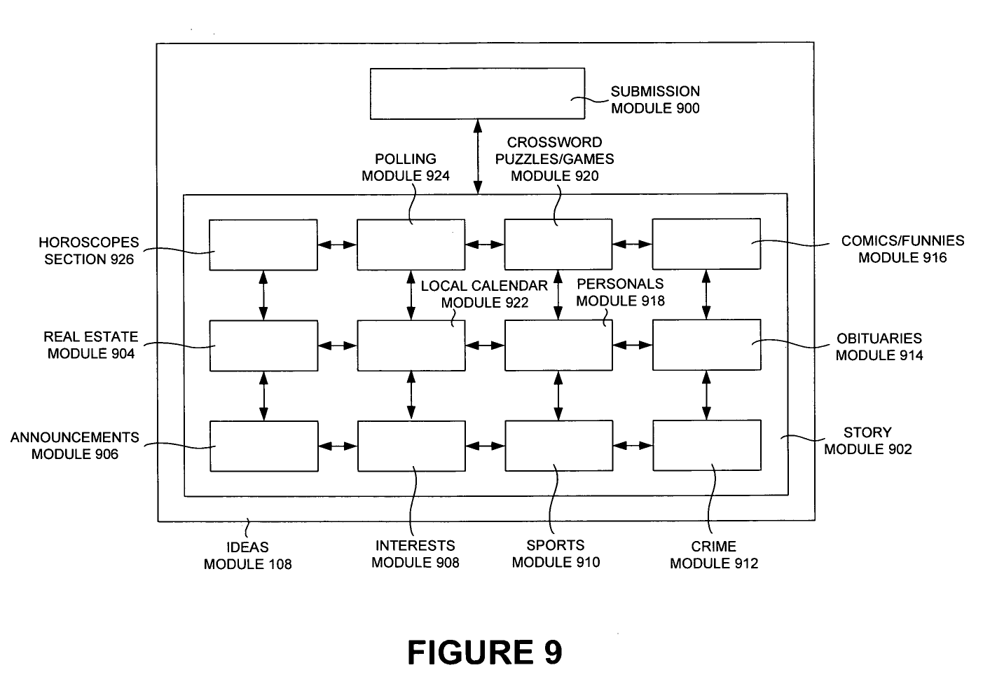

FIG. 9 is an exploded view of an ideas module 108 of FIG. 1, according to one embodiment. Particularly, FIG. 9 illustrates the ideas module 108 which includes a submission module 900 and a story module 902 according to one embodiment. The story module 902 also includes a real estate module 904, an announcements module 906, an interests module 908, a sports module 910, a crime module 912, an obituaries module 914, a comics/funnies module 916, a personals module 918, a crossword puzzles/games module 920, a local calendar module 922, a polling module 924 and a horoscopes section 926, according to one embodiment.

The ideas module 108 may manage a set of user-generate ideas of a reader group of the community publication and may organize submitted ideas such that the submitted ideas identify a structured data in which the ideas become submittable for consideration in a future community publication. The submission module 900 may allow the user to post their contents (e.g., a story, a poem, a joke etc.) on the markup page. The story module may allow the user to write content (e.g., a story, a poem, a joke etc.) of their own topic on the markup page. The real estate module 904 may provide the user with information associated with the real property (e.g., land, house and/or office for sale and/or rent etc.).

The announcements module 906 may enable a usenet, mailing list, or e-mail message sent to notify the user in the geo-spatial environment. The interests module 908 may enable the user to participate in at least one of the recreations and/or provide information to the user associated to their interests. The sports module 910 may provide the user with the information associated with the sports and/or may maintain information associated with the sports provided by the registered users of the geo spatial environment. The crime module 912 may maintain, update and/or provide the user information associated with any criminal events happening in the society (e.g., a theft, a murder, a curfew etc).

The obituaries module 914 may allow the user to post the death anniversary of any of their kin or kith (e.g., a relative, a friend, a colleagues etc.). The comics/funnies module 916 may allow the user to post their interests of comics viewable to other users. The personals module 918 may provide and/or maintain item and/or notice personal in nature (e.g., personals may generally be meant to find romance or friendship, and usually include a basic description of the person posting it, and their interests.).

The crossword puzzles/games module 920 may provide the user to post/access the games been posted in the markup page (e.g., a quiz, a puzzler etc.). The local calendar module 922 may notify the user to mark the important events (e.g., a conference, a weekly meetings etc.). The polling module 924 may maintain a record and/or enable the user to give the ratings to the privileges of the posted items in the markup page. The horoscopes section 926 may allow the user to get notified with the updated horoscopes.

In an example embodiment as illustrated in FIG. 9 the submission module 900 may communicate with the story module 902 of the ideas module 108. The real estate module 904, the announcements module 906, the interests module 908, the sports module 910, the crime module 912, the obituaries module 914, the comics/funnies module 916, the personals module 918, the crossword puzzles/games module 920, the local calendar module 922, the polling module 924 and the horoscopes section 926 of the ideas module 108 may communicate with each other.

For example the submission form may be processed when the submit the story idea indicator is selected, and/or the submitted story idea may be added that is geo-tagged to a location identifier of the user to an ideas database, and/or which remains in the ideas database for a threshold amount of time. The status of a different user may be transferred to being a community journalist when the different user elects the become the journalist indicator. The status of the submitted story idea as being checked out when the community journalist selects the submitted story idea as being one which the community journalist chooses to author may be altered. Each reader of the community publication may vote on submitted story ideas for publication consideration in a future community publication based on a popularity of any particular submitted story idea with readers. Each reader of the community publication can vote on submitted story ideas for publication consideration in a future community publication based on a popularity of any particular submitted story idea with readers.

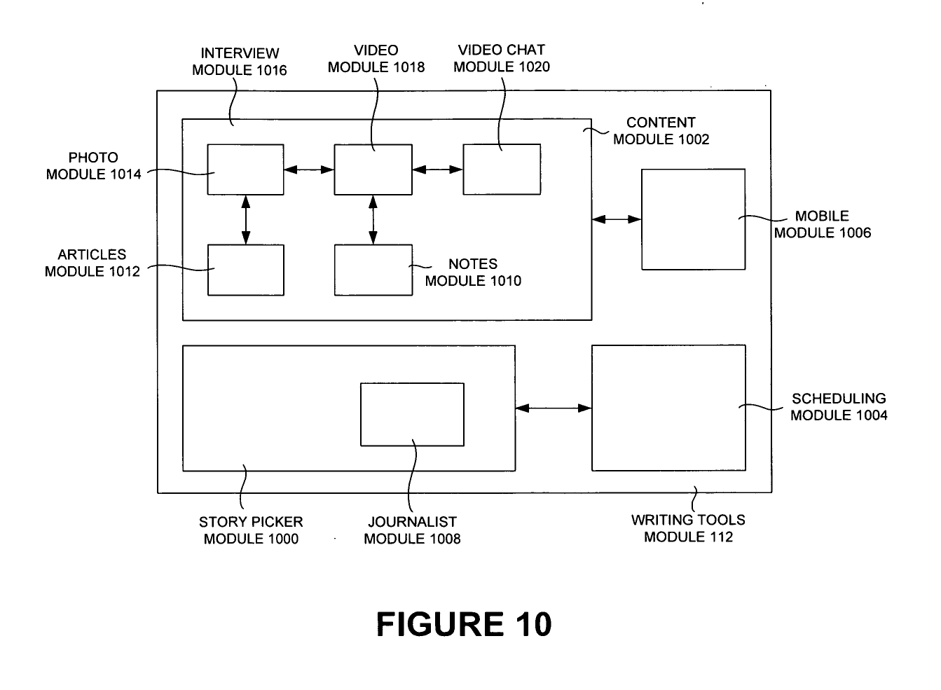

FIG. 10 is an exploded view of a writing tools module 112 of FIG. 1, according to one embodiment. Particularly, FIG. 10 illustrates the a story picker module 1000, a content module 1002, a scheduling module 1004, a mobile module 1006, a journalist module 1008, a notes module 1010, an articles module 1012, a photo module 1014, an interview module 1016, a video module 1018 and a video chat module 1020, according to one embodiment.

The story picker module 1000 may allow the user to write and/or upload a story of their choice on the markup page. The content module 1002 may maintain and/or allow the user to write and/or upload the content like stories, tit-bits, jokes, poems etc on the markup page. The scheduling module 1004 may track and/or inform the user about the schedule of the events (e.g., an announcement, an auction, an exhibition etc). The mobile module 1006 may receive information and may send it to the users mobile device such as cell phone, pager etc.

The journalist module 1008 may maintain, update and/or provide the user to write any information in the markup page. The notes module 1010 may maintain and/or allow the user to write comments and/or notes. The articles module 1012 may allow the user to post their articles on the markup page and/or maintain and/or update the articles. The photo module 1014 may maintain and/or allow the user to upload the desired photos on the markup page.

The interview module 1016 may allow conversation between two or more people (The interviewer and the interviewee) where questions are asked by the interviewer to obtain information from the interviewee. The video module 1018 may allow the user to see a display (e.g., Images, photos, Videos etc.) on the screen. The video chat module 1020 may allow the users to chat with the person online.

In an example embodiment as illustrated in FIG. 10, the story picker module 1000 may communicate with the scheduling module 1004. The interview module 1016 may communicate with the mobile module 1006. The video module 1018 may communicate with the notes module 1010, the video chat module 1020 and the articles module 1012 through the photo module 1014.

For example a timer may be determined for a duration of a checked out status of the submitted story idea, and/or the timer may be reset when the community journalist authors an article based on the submitted story idea and/or the article to a journalism module may be submitted. The community publication based on the article may be automatically generated and/or other articles submitted by other community journalists at a periodically occurring interval. The writing tools module may enable some of the users of a geospatial environment to elect stories they wish to write articles on.

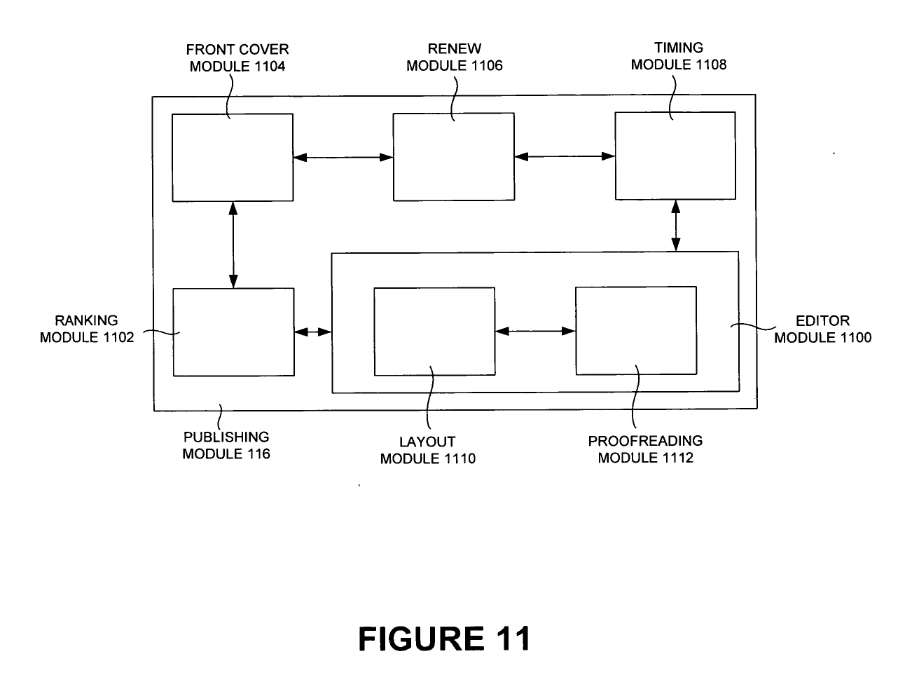

FIG. 11 is an exploded view of a publishing module 116 of FIG. 1, according to one embodiment. Particularly FIG. 11, illustrates a editor module 1100, a rankings module 1102, a front cover module 1104, a renew module 1106, a timing module 1108, a layout module 1110, a proof reading module 1112, a publishing module 116. The publishing module 116 may be concerned with the production and dissemination of literature, information and/or an activity of making information available for public view. The editor module 1100 enable a process of preparing language, images, and/or sound for presentation through correction, condensation, organization, and other modifications.

The rankings module 1102 may facilitate a process of positioning items such as individuals, groups and/or businesses on an ordinal scale in relation to others in the geo-spatial environment. The front cover module 1104 may facilitate the title and/or author, with possibly an appropriate illustration for the story and/or idea been published. The renew module 1106 may regenerate and/or redevelop any items present in the publishing module. The timing module 1108 may provide with the range of time synchronization solutions to ensure that the time is accurate to within a fraction of a second for a specific task in the geo-spatial environment.

The layout module 1110 may defines the physical layout of a webpage and/or defines the location of the navigation portion (e.g., the top and bottom part of the webpage) as well as the location of where the body or screen of the page is. The proof reading module 1112 may perform reading a proof copy of a text in order to detect and/or correct any errors in the ideas and/or stories been published in by the users in the geospatial environment.

The editor module may include the layout module 1110 communicating with the proof reading module 1112. The rankings module 1102 may communicate with the editor module 1100 and the front cover module 1104. The renew module 1106 may communicate with the front cover module 1104 and the editor module 1100 through timing module 1108 of the publishing module 116.

For example the continuing qualification may be automatically determined by the community journalist based on responses to the timer, and/or a peer feedback rating and/or a reader feedback rating of the article authored by the community journalist. The community journalist may provide a consideration to a form of at least one of a monetary award, a salary, and/or a recognition point based on at least one of the peer feedback rating a number of reader page views, the reader feedback, and/or an advertising revenue generated based on geo-spatially targeted advertisements adjacent to at least one of the article and/or a community publication. The community publication based on the article may be automatically generated and/or other articles submitted by other community journalists at a periodically occurring interval. The user generated content having relevant news to a geo-spatially meta-tagged community at a predefined frequency may be created by the publishing module (e.g., the publishing module 116 of FIG. 1).

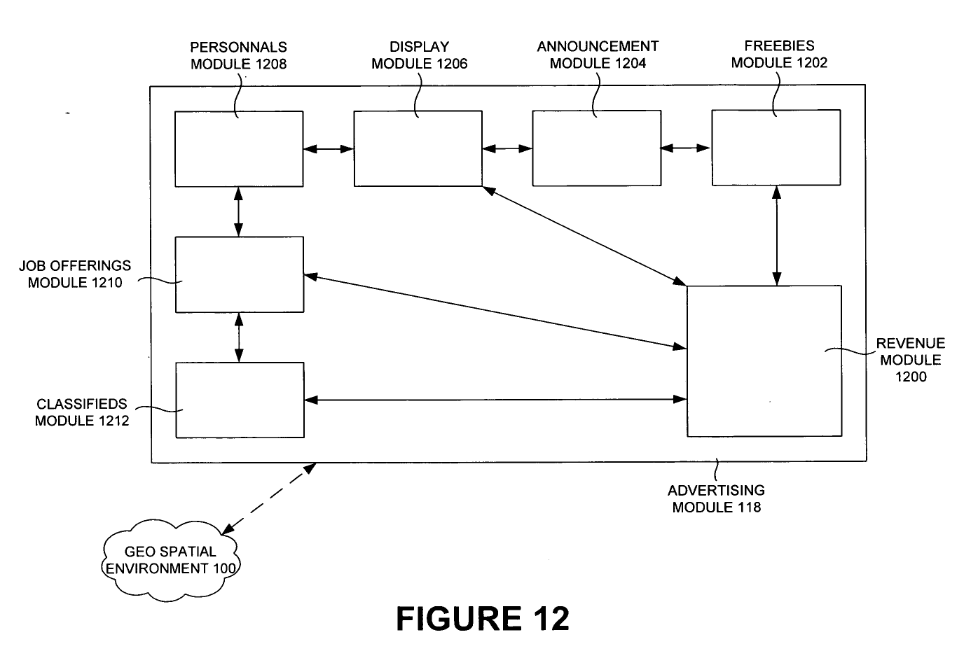

FIG. 12 is an exploded view of an advertising module 118 of FIG. 1, according to one embodiment. Particularly FIG. 12 illustrates a geo-spatial environment 100, a revenue module 1200, a freebies module 1202, an announcement module 1204, a display ad module 1206, a personals module 1208, a job offerings module 1210 and a classifieds module 1212. The advertising module 118 may enable publicity, public relations, product placement, sponsorship, underwriting and/or sales promotion in the geo-spatial environment.

The revenue module 1200 may identify the advertisers and ad networks that bring the most revenue into the remnant space and/or report the total revenue data per advertiser and/or ad network. The freebies module 1202 may enable a product or service that is given away without charge. The announcement module 1204 may be associated with a declaration and/or statement regarding any advertisements to be made in the geo-spatial environment. The display ad module 1206 may facilitate advertising that may contain graphic information beyond text such as logos, photographs and/or other pictures, location maps and/or similar items.

The personals module 1208 may be associated with publishing an item and/or notice traditionally in the newspaper, similar to a classified ad but personal in nature. The job offerings module 1210 may define and/or maintain complex thresholds, situations, workflow policies and alerts a job openings for the users of the geo-spatial environment. The classifieds module 1212 may maintain a form of advertise with detail, such as name to contact, address to contact or visit, a detailed description of the product or products. The geo-spatial environment 100, may be a combination of spatial software and analytical methods with terrestrial or geographic datasets.

The advertising module 118 may communicate with the geo-spatial environment 100. The revenue module 1200 may communicate with the freebies module 1202, the display ad module 1206, the job offerings module 1210 and the classifieds module 1212 of the advertising module 118. The personals module 1208 may communicate with the announcement module 1204 through the display ad module 1206.

For example the community journalist may be provided with a consideration in the form of a monetary award, a salary, and/or a recognition point based on at least one of the peer feedback rating a number of reader page views, the reader feedback, and/or an advertising revenue generated based on geo-spatially targeted advertisements adjacent to at least one of the article and/or a community publication. The community publication based on the relevant content submitted by the community journalist, other community journalists, and/or a user generated content data that includes an announcement data, a classifieds data, a user generated games data, and/or a personals data submitted by users who have joined a group which associates and/or subscribes them to the community publication may be generated.

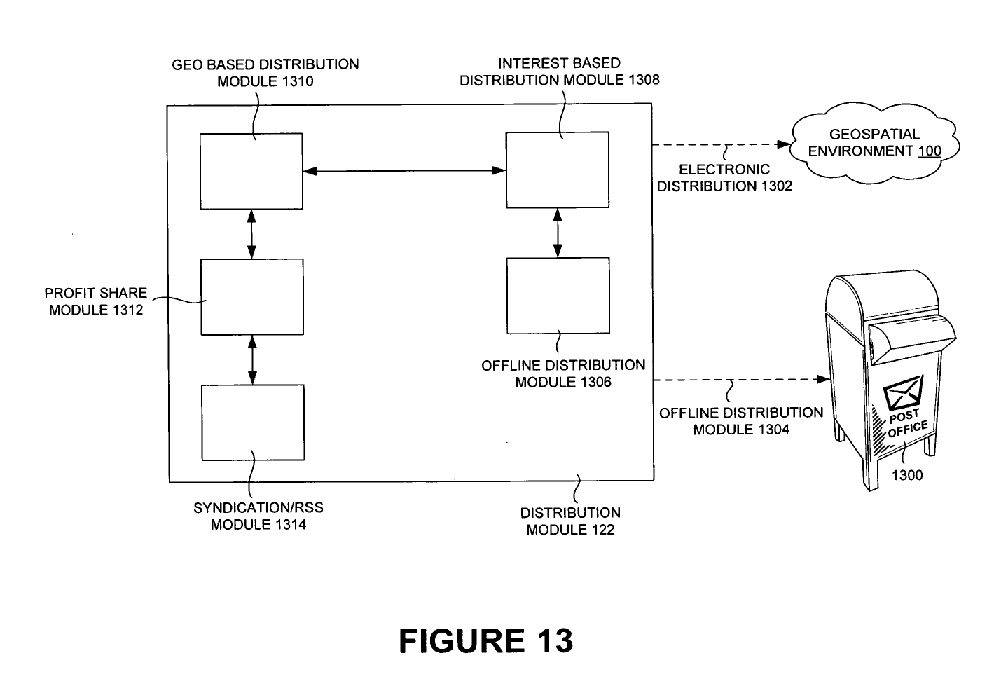

FIG. 13 is an exploded view of a distribution module 122 interacting with the geo-spatial environment 100 and the post office 1300, according to one embodiment. Particularly, FIG. 13 illustrates the geo-spatial environment 100, the distribution module 122, a post office 1300, an electronic distribution 1302, an offline distributions 1304, an offline distribution module 1306, an interest based distribution module 1308, a geo based distribution module 1310, a profit share module 1312 and a syndication/RSS module 1314.

The geo-spatial environment 100 may be a combination of spatial software and analytical methods with terrestrial or geographic datasets. The distribution module 122 may enable the user to spread, disperse, consign, sell, barter, offer for sale, solicit, circulate, give out and/or otherwise deal with the product and/or information in a geo-spatial environment. The post office 1300 may be a facility authorized by a postal system for the posting, receipt, sorting, handling, transmission or delivery of mail in the geo-spatial environment. The offline distribution 1304 may facilitate distribution of information between distribution module and the post office 1300.

The offline distribution module 1306 may allow finally downloading audio, documents, videos and/or uploading them to the mobile device. The interest based distribution module 1308 may share information to the users based on the user's area of interest in the geo spatial environment. The geo based distribution module 1310 may globally supply the contents present in the distribution module 122. The profit share module 1312 may incentive plans introduced by businesses that provide direct or indirect payments to the users of the geo-spatial environment. The syndication/RSS module 1314 may be a family of web feed formats used to publish frequently updated digital content, such as blogs, news feeds or podcasts.

In example embodiment as illustrated in FIG. 13, the distribution module interacts with the geo-spatial environment 100 through electronic distribution 1302 and the post office 1300 through the offline distribution module 1306. The geo based distribution module 1310 may communicate with the offline distribution module 1306 through the interest based distribution module 1308, and may also communicate with the syndication/RSS module 1314.

For example the community publication may be published in the geospatial environment to targeted users distributable to the electronic location of at least a subset of the targeted users subscribing to the community publication when the electronic location is available. The community publication to another subset of the targeted users based on a mailing to the physical location of the targeted users, wherein the another subset of the targeted users have at least one of a self declared subscription to the community publication and/or which are targeted as being possibly interested in the community publication may be created.

The distribution (e.g., the distribution module 122 of FIG. 1, FIG. 13) module may automatically distribute to the user generated content to a members of a group associated with a target demographic associated with the user generated content by associating a meta-data associated with members of the group with a physical postal address and automatically generating a community publication to distribute to the group. The profit share module (e.g., the profit share module 1312 of FIG. 13) may allocate profits from revenues of classified and display advertisements in the community publication with authors of articles of the community publication, community journalists, an editor, idea submitters, and others who have submitted user generated content in the community publication to provide incentive providing future relevant and timely content in future community publications.

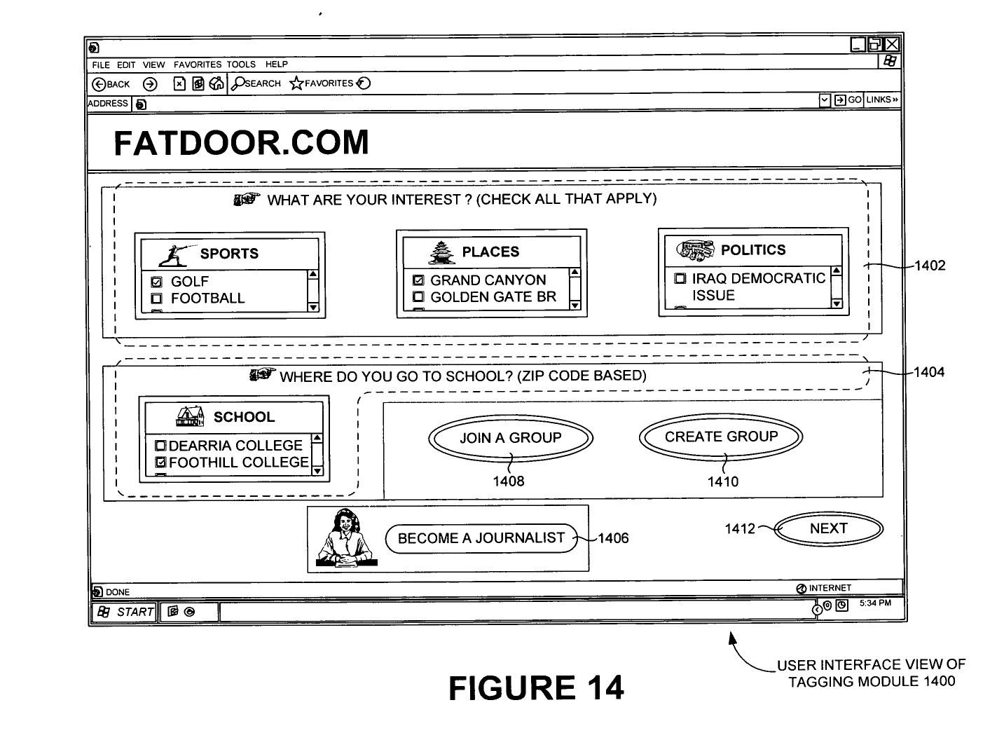

FIG. 14 is a user interface view 1400 of tagging module, according to one embodiment. The subject 1402 may provide data like user's interests like sports, places of interest and/or politics in a form. The subject 1404 may provide data like user's bio associated to a school, college and/or Zip code based address information in the markup page. The become a journalist option 1406 may enable the user to take responsibility for gathering and dissemination of information about current events, trends, issues and people and/or posting the contents in the markup page that may be accessible by other users.

The join a group option 1408 may enable the user to join a group of users having common interests, can build an online relationship in the networks where the users may share interests with others in the same group. The create group option 1410 may enable the user to create a group of users having common interests that may build an online relationship in the networks where the users may share interests with others in the same group. The next option 1412 may enable the user to navigate to other web pages via hypertext links.

In an example embodiment as illustrated in FIG. 14, the user interface view of the tagging module may be a mark up page. The mark up page may include sub-windows and/or many hypertext links. For example, in the markup page a sub-window of the markup language may provide the user's interests (e.g., sports, places of interest and politics) in a form, the subject 1404 may be a sub-window of the Markup language which may provide the user's bio (e.g., school, college and Zip code based address) in a form, the become a journalist option 1406 may be a hypertext link of the mark up page (e.g., become a journalist option 1406 may enable the user to post the contents), the join a group option 1408 may be a hypertext link of the mark up page (e.g., join a group option 1408 may allow the user to join in a group having people of common interests). The user may create a group having people of common interests and share his interest with the members of the group by creating a group.

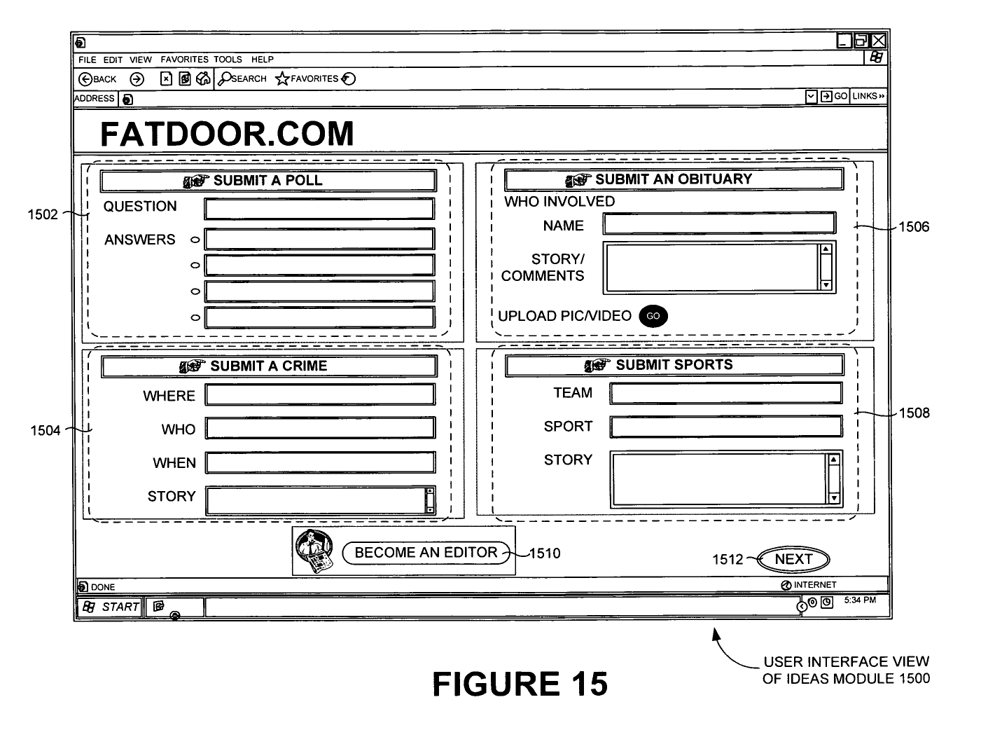

FIG. 15 is a user interface view of ideas module, according to one embodiment. Particularly, FIG. 15 illustrates a submit a poll 1502, a submit a crime 1504, submit an obituary 1506, submit sports 1508, become an editor option 1510 and a next option 1512. The submit a poll 1502 may be a window box in a markup page in which the user may provide data in a form of question and/or answers in a markup page. The submit a crime 1504 may be a window box of the mark up page in which the user may provide information regarding an act that violates a very important political, religious and/or moral command and/or crimes in the geo-spatial environment.

The submit an obituary 1506, may be the window of the mark up page in which a notice of the death of a person including a short biography may be published by the user. The submit sports 1508 may be a window box in markup page in which the user may provide information about an activity such as games and/or sports that may be shared to other user on uploading. The become an editor option 1510, may enable the user to upload, edit and/or update any stories, ideas and/or information in the markup page thus providing the user to be a editor. The next option 1512, may be a window of the markup page which may provide the user proceed to the further pages.

In an example embodiment as illustrated in FIG. 15, the user interface view of ideas module 1500, may be a mark up page. The mark up page may include many sub windows and/or sub mark up pages. The user may upload, edit and/or provide information related to may be poll, a crime, an obituary in the markup page that may be viewable to the other users of the geo-spatial environment. The submit a poll 1502 may include questions and answer part to be filled by the user. The submit a crime 1504 may need the user to feed the information like where, who, when and/or the story of the crime been committed. The submit an obituary 1506 may include details like who involved, name, story, comments and/or upload the pictures related to the article. The user may need to fill and/or update the information related to a team, sport and/or the story in the submit sports 1508.

The story ideas may be allocated to a different user who has elected to be a community journalist in the geo-spatial social network, and, in response to a article submission by the community journalist, automatically formatting and screening relevant content when approved by a community editor.

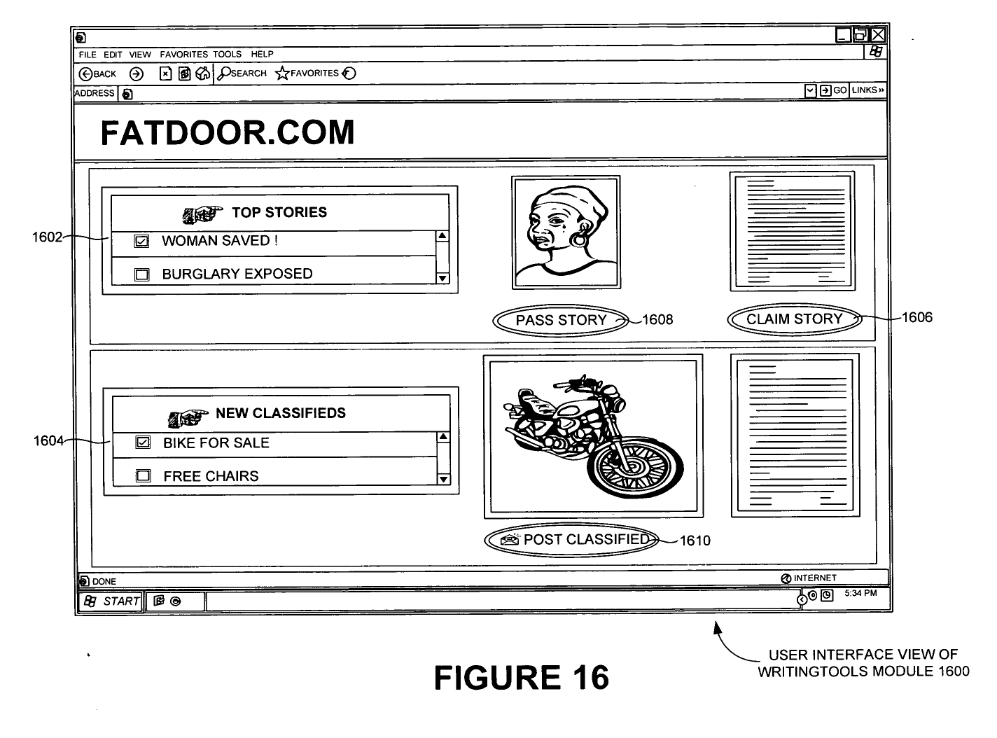

FIG. 16 is a user interface view of writing tools module, according to one embodiment. The top stories 1602 may provide latest events published by the user (e.g., woman saved, burglary exposed etc.) in a form. The new classifieds 1604 may provide information associated to buy/sell and/or rent property to a user in the geo-spatial environment. The claim story 1606 may be an option which may enable the user to demand the rights of claiming the story dealing with an individual.

The pass story option 1608 may enable the registered user to allow the story accessible to the other users. The post classified option 1610 may enable the user to post advertisements which may be grouped under different classifications of the product or service being offered (e.g., accounting, automobiles, clothing, jobs, auction, farm produce, for sale, for rent, etc.)

In the example embodiment as illustrated in FIG. 16 the user interface view of writing tools module 1600 may enable the user to view any event been published by other users in the top stories 1602. For example, woman been saved, burglary exposed etc. The new classified may enable the user to buy and/or sell any objects. For example, bike for sale, free chairs etc. The user may pass any stories to other users and/or claim any publications, ideas and/or stories been updated in the markup page.

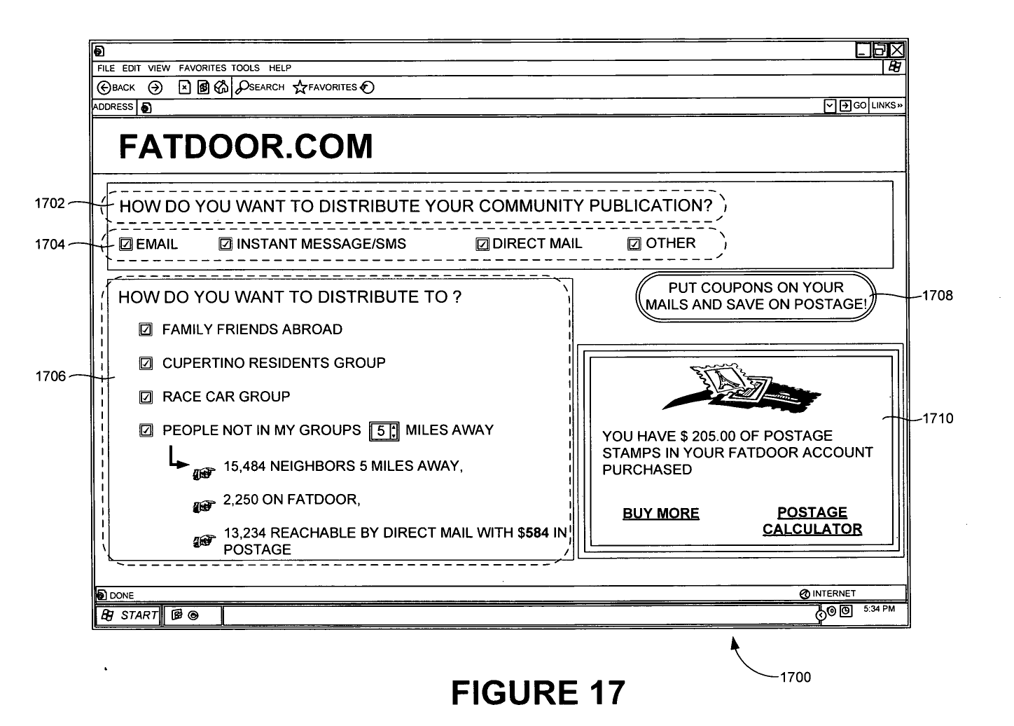

FIG. 17 is a user interface view distributing an article in a geospatial environment, according to one embodiment. Particularly, FIG. 17 illustrates a mark up page 1700, which may be an user interface including many sub windows for example there may be a how do you want to distribute your community publication 1702, which may provide information to the user, how the user community publication may be distributed. The sub mark up page 1704 of the mark up page 1700 may provide the user to communicate with the help of many options for example email, a instant message/SMS, a direct mail other.

The sub mark up page 1706 may provide the user with the options in the mark up page 1700 which may provide information to the user, how to distribute, for example distribution may be done by family friends, Cupertino residents, race car group and/or people not in my groups miles away. The sub markup page window 1708 may also interact with the user to provide coupons and stamps for the mails. The sub markup page window 1710 of the mark up page 1700 may also provide information to the user about balance remaining in account for example the information may be balance of $205 of postage stamps in your account purchased.

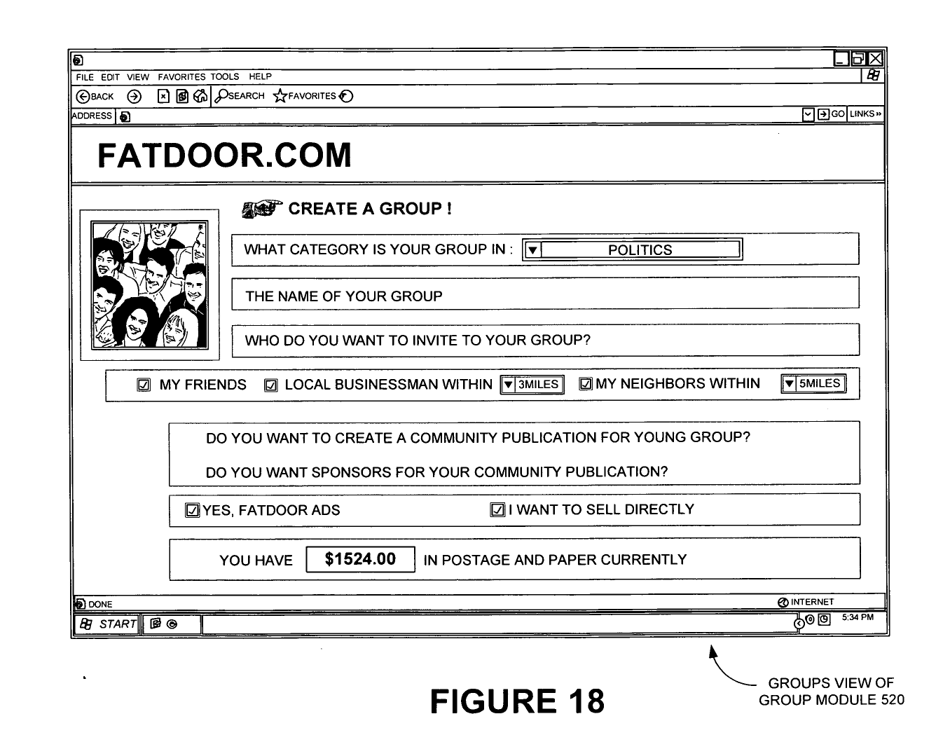

FIG. 18 is a user interface view of groups module 520, according to one embodiment. Particularly, FIG. 18 illustrates the sharing of information about the user. The user may create a group and may also specify to which category the user may belonging to, along with his name of the group. The groups view of groups module 520 may also provide the user with an option to who he may include in his group such as my friends, local business, my neighbors within. It may also provide information to the user about his balance. This may also inform the user about his balance remaining in his postage and/or paper currently.

For example, the community publication to a group may be generated based on at least one of a geographic location of the group, a common professional interests of the group, a religious affiliation of the group, a friendship between members of the group, an educational institution associated with the group, a cultural affiliation of the group, a political interest of the group, and a social interest of the group. The community publication in any of a selectable number of languages based on readership preferences of the members of the group and/or a moderator user who serves as an editor and publisher of the community publication in the geo-spatial environment (e.g., the geo-spatial environment 100 of FIG. 1) may be automatically generated. The article (e.g., the articles 114 of FIG. 1) in an electronic version of the community publication based on a popularity of the article as elected by readers of the article in the electronic version of the community publication may be automatically repositioned.

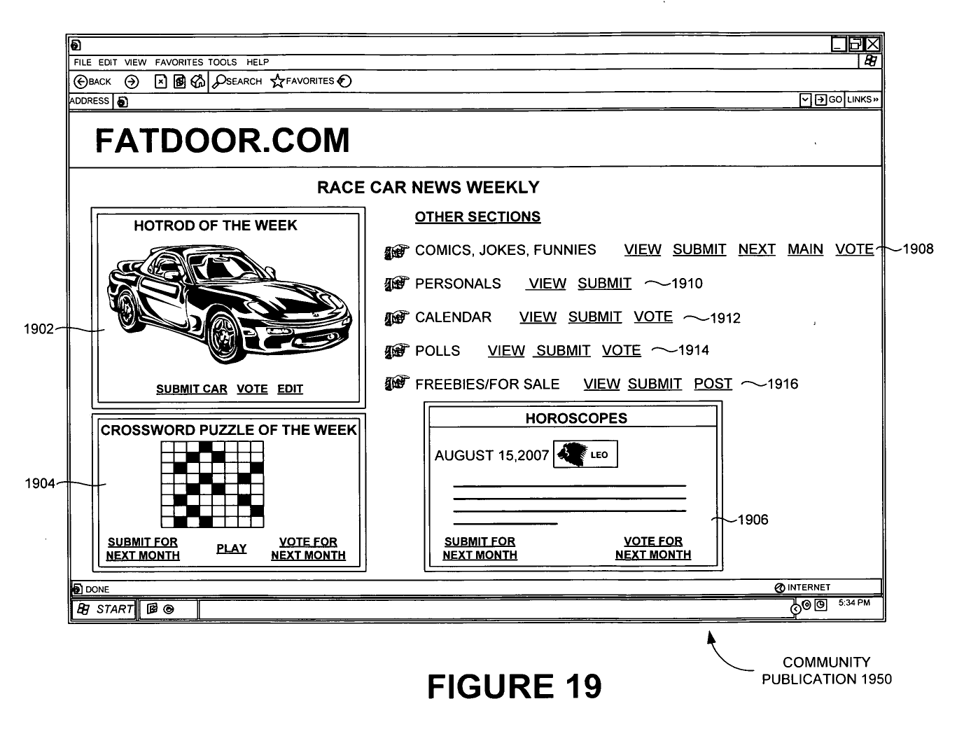

FIG. 19 is a user interface view of distribution among the users, according to one embodiment. Particularly, FIG. 19 may include a hotrod of the week 1902, a crossword puzzle of the week 1904, horoscopes 1906, a comics, jokes, funnies view 1908, a personals 1910, a calendars 1912, a polls 1914, freebies/for sale 1916. The community publication 1950 may be the user interface view which may communicate with the user to provide information regarding submit car vote edit 1902. there may be sub mark up page also which may be informing the user about the game of the week example cross word puzzle of the week 1904. the community publication 1950 may also provide the user with information regarding horoscopes 1906.

The horoscope may be a chart and/or diagram representing the positions of the planets, other celestial bodies, and/or sensitive angles at the time of any event, for example a moment of a person's birth. There may be other sections for the user to interact for example, a comics which may be to illustrate caricatures and/or to entertain through the use of amusing and/or trivial stories, it may evolve a literary medium with many subgenres, jokes may be a short story and/or series of words spoken and/or communicated with the intent of being laughed at and/or found humorous by either listener/reader and/or performer/writer, funnies view 1908, personals 1910, calendars 1912 may be a system for naming periods of time, typically days, polls 1914, freebies/for sale 1916 the submit play vote for next month.

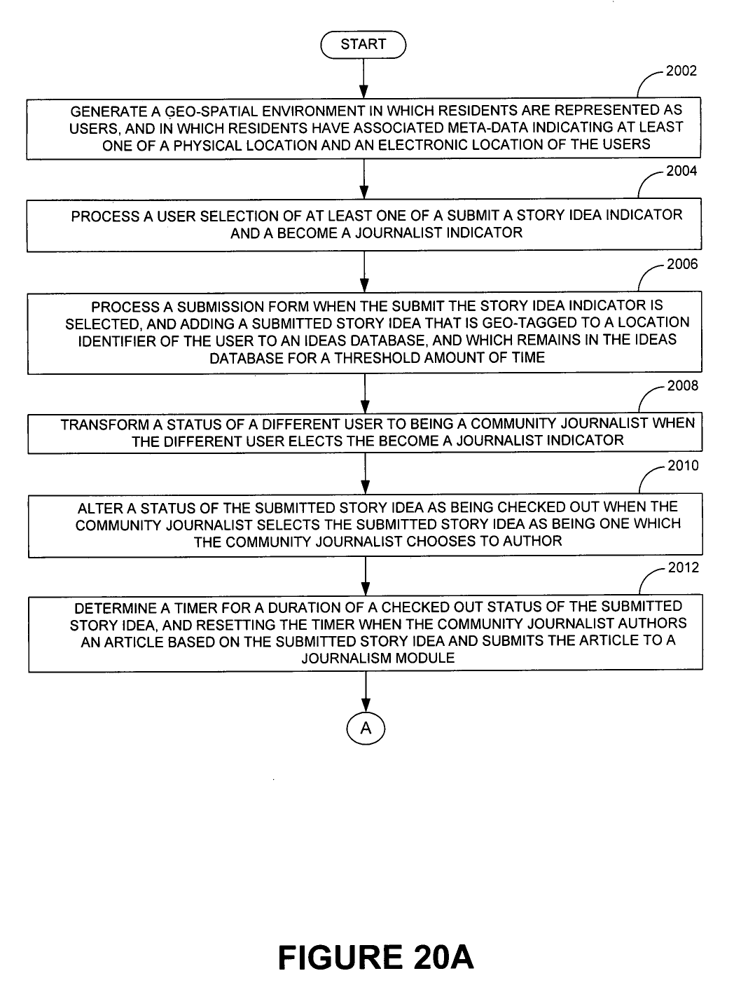

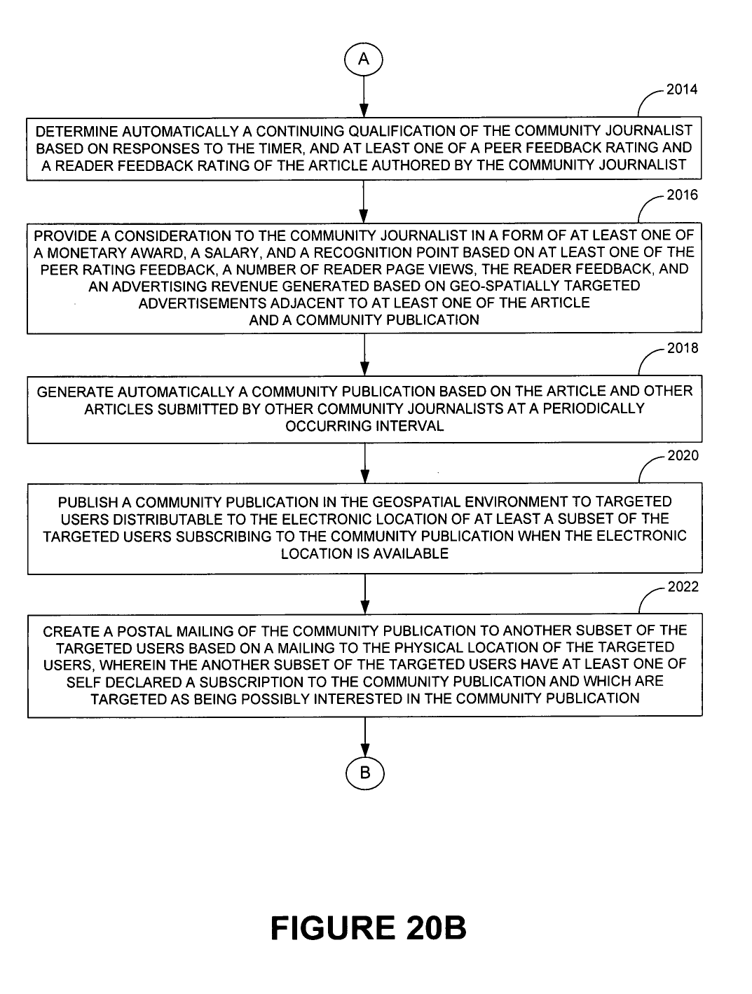

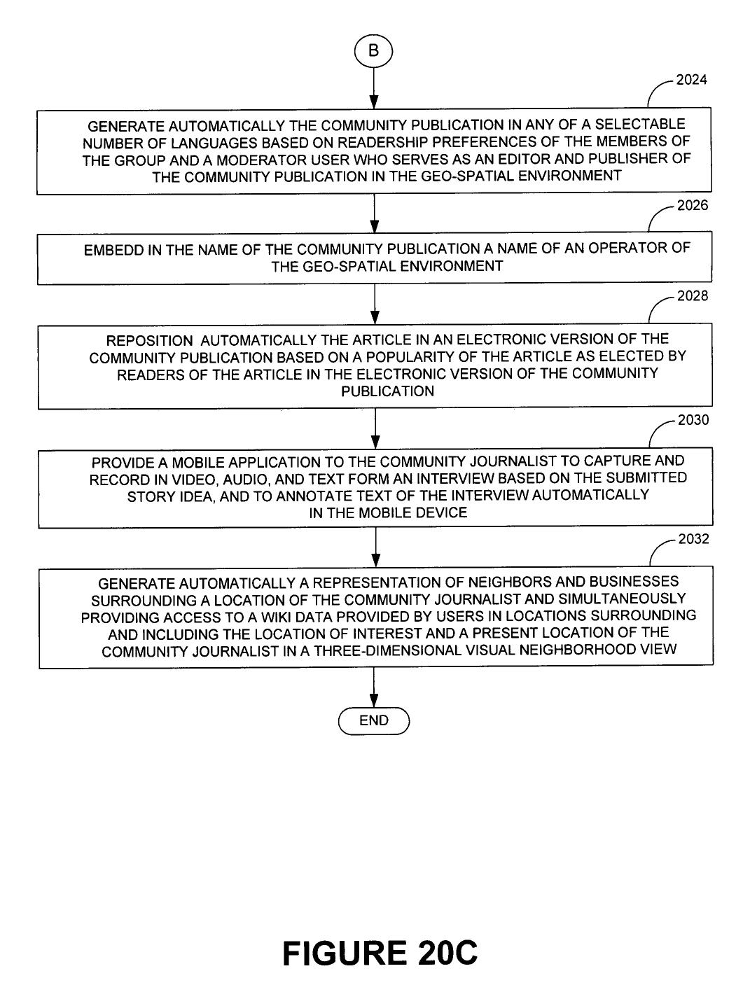

FIG. 20A is a process flow of submitting story idea in the created geo-spatial environment, according to one embodiment. In operation 2002, a geo-spatial environment may be generated in which residents are represented as users, and in which residents have associated meta-data indicating at least one of a physical location and an electronic location of the users. In operation 2004, a user selection of at least one of a submit a story idea indicator and a become a journalist indicator may be processed.

In operation 2006, a submission form may be processed when the submit the story idea indicator is selected, and adding a submitted story idea that is geo-tagged to a location identifier of the user to an ideas database, and which remains in the ideas database for a threshold amount of time. In operation 2008, a status of a different user may be transformed to being a community journalist when the different user elects the become a journalist indicator (e.g., the become a journalist option 1406 of FIG. 4).

In operation 2010, a status of the submitted story idea as being checked out may be altered when the community journalist selects the submitted story idea as being one which the community journalist chooses to author. In operation 2012, a timer for a duration of a checked out status of the submitted story idea, and resetting the timer may be determined when the community journalist authors an article based on the submitted story idea and submits the article to a journalism module.

FIG. 20B is a continuation of process flow of FIG. 20A showing additional processes, according to one embodiment. In operation 2014, a continuing qualification of the community journalist may be automatically determined based on responses to the timer, and at least one of a peer feedback rating and a reader feedback rating of the article authored by the community journalist. In operation 2016, a consideration to the community journalist may be provided in a form of at least one of a monetary award, a salary, and a recognition point based on at least one of the peer rating feedback, a number of reader page views, the reader feedback, and an advertising revenue generated based on geo-spatially targeted advertisements adjacent to at least one of the article and a community publication.

In operation 2018, a community publication may be automatically generated based on the article and other articles submitted by other community journalists at a periodically occurring interval. In operation 2020, a community publication may be published in the geospatial environment (e.g., the geo-spatial environment 100 of FIG. 1) to targeted users distributable to the electronic location of at least a subset of the targeted users subscribing to the community publication when the electronic location is available.

In operation 2022, a postal mailing of the community publication to another subset of the targeted users may be created based on a mailing to the physical location of the targeted users, wherein the another subset of the targeted users have at least one of self declared a subscription to the community publication and which are targeted as being possibly interested in the community publication.

FIG. 20C is a continuation of process flow of FIG. 20B showing additional processes, according to one embodiment. In operation 2024, the community publication may be automatically generated in any of a selectable number of languages based on readership preferences of the members of the group and a moderator user who serves as an editor and publisher of the community publication in the geo-spatial environment. In operation 2026, in the name of the community publication a name of an operator of the geo-spatial environment may be embedded.

In operation 2028, the article may be automatically repositioned in an electronic version of the community publication based on a popularity of the article (e.g., the articles 114 of FIG. 1) as elected by readers of the article in the electronic version of the community publication. In operation 2030, a mobile application may be provided to the community journalist to capture and record in video, audio, and text form an interview based on the submitted story idea, and to annotate text of the interview automatically in the mobile device.

In operation 2032, a representation of neighbors and businesses surrounding a location of the community journalist and simultaneously providing access to a wiki data provided by users in locations surrounding and including the location of interest and a present location of the community journalist may be automatically generated in a three-dimensional visual neighborhood view.

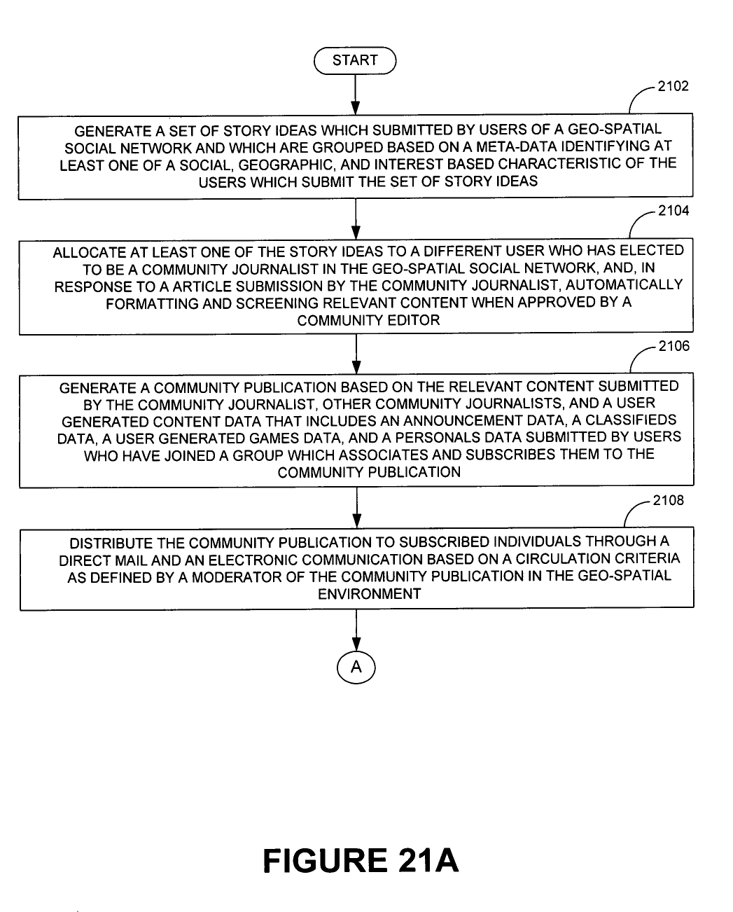

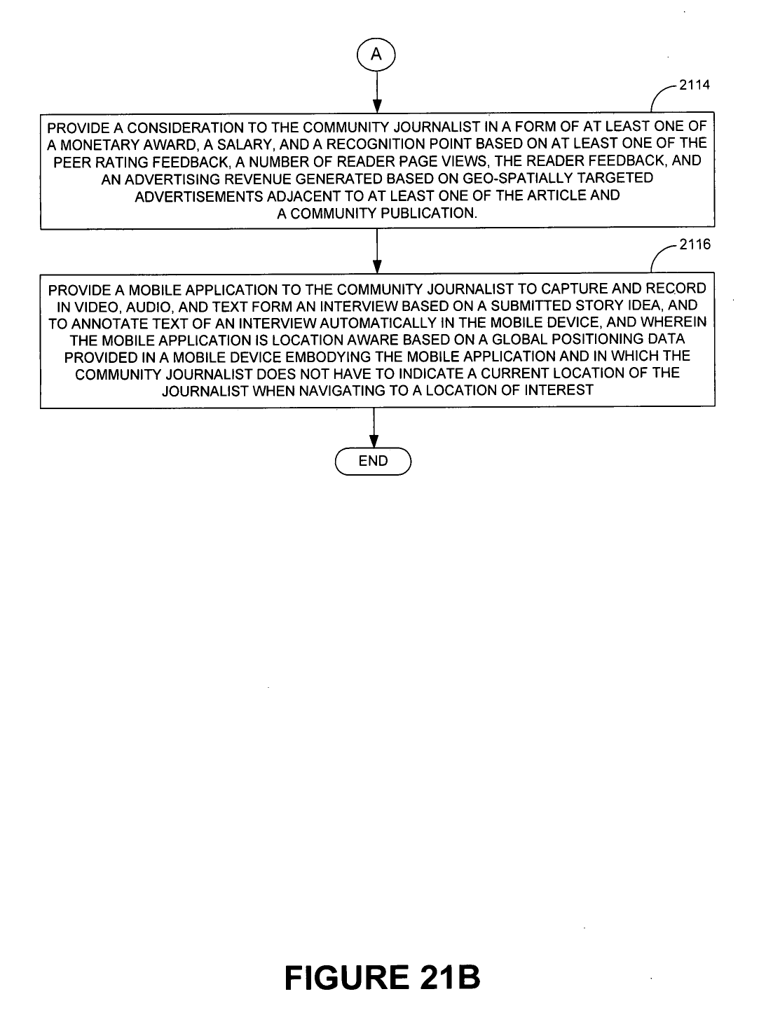

FIG. 21A is a process flow of generating, submitting and publishing the content in the geo-spatial environment, according to one embodiment. In operation 2102, a set of story ideas which are submitted by users of a geo-spatial social network and which are grouped based on a meta-data identifying at least one of a social, geographic, and interest based characteristic of the users which submit the set of story ideas may be generated. In operation 2104, at least one of the story ideas may be allocated to a different user who has elected to be a community journalist in the geo-spatial social network, and, in response to a article submission by the community journalist, automatically formatting and screening relevant content when approved by a community editor.

In operation 2106, a community publication may be generated based on the relevant content submitted by the community journalist, other community journalists, and a user generated content data that includes an announcement data, a classifieds data, a user generated games data, and a personals data submitted by users who have joined a group which associates and subscribes them to the community publication. In operation 2108, the community publication to subscribed individuals may be distributed through a direct mail and an electronic communication based on a circulation criteria as defined by a moderator of the community publication in the geo-spatial environment.

FIG. 21B is a continuation of process flow of FIG. 20A showing additional processes, according to one embodiment. In operation 2110, a consideration to the community journalist may be provided in a form of at least one of a monetary award, a salary, and a recognition point based on at least one of the peer rating feedback, a number of reader page views, the reader feedback, and an advertising revenue generated based on geo-spatially targeted advertisements adjacent to at least one of the article and a community publication.

In operation 2112, a mobile application may be provided to the community journalist to capture and record in video, audio, and text form an interview based on a submitted story idea, and to annotate text of an interview automatically in the mobile device, and wherein the mobile application is location aware based on a global positioning data provided in a mobile device embodying the mobile application and in which the community journalist does not have to indicate a current location of the journalist when navigating to a location of interest

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium).

For example, the user geo-tagging module 102, the ideas module 108, the writing tools module 112, the publishing module 116, the advertising module 118, the distribution module 122, the GPS module 302, the revenue module 508, the announcement module 510, the classifieds module 512, the advertising module 514, the profit share module 516, the incentive module 518, the groups module 520, the interest module 800, the school module 802, the age module 804, the religion module 806, the ethnicity module 808, the places module 810, the politics module 812, the country module 814, the state module 816, the city module 818, the ZIP module 820, the submission module 900, the story module 902, the real estate module 904, the announcements module 906, the interests module 908, the sports module 910, the crime module 912, the obituaries module 914, the comics/funnies module 916, the personals module 918, the crossword puzzles/games module 920, the local calendar module 922, the polling module 924, the story picker module 1000, the content module 1002, the scheduling module 1004, the mobile module 1006, the journalist module 1008, the notes module 1010, the articles module 1012, the photo module 1014, the interview module 1016, the video module 1018, the video chat module 1020, the editor module 1100, the rankings module 1102, the front cover module 1104, the renew module 1106, the timing module 1108, the layout module 1110, the proof reading module 1112, the publishing module 116, the revenue module 1200, the freebies module 1202, the announcement module 1204, the display ad module 1206, the personals module 1208, the job offerings module 1210, the classifieds module 1212, the offline distribution module 1306, the interest based distribution module 1308, the geo based distribution module 1310, the profit share module 1312 and the syndication/RSS module 1314 of FIG. 1-13 may be embodied through a user geo-tagging circuit, an ideas circuit, a writing tools circuit, a publishing circuit, a advertising circuit, a distribution circuit, a GPS circuit, a revenue circuit, an announcement circuit, a classifieds circuit, an advertising circuit, a profit share circuit, an incentive circuit, a groups circuit, an interest circuit, a school circuit, an age circuit, a religion circuit, an ethnicity circuit, a places circuit, a politics circuit, a country circuit, a state circuit, a city circuit, a ZIP circuit, a submission circuit, a story circuit, a real estate circuit, an announcements circuit, an interests circuit, a sports circuit, a crime circuit, an obituaries circuit, a comics/funnies circuit, a personals circuit, a crossword puzzles/games circuit, a local calendar circuit, a polling circuit, a story picker circuit, a content circuit, a schedule circuit, a mobile circuit, a journalist circuit, a notes circuit, an articles circuit, a photo circuit, an interview circuit, a video circuit, a video chat circuit, a editor circuit, a rankings circuit, a front cover circuit, a renew circuit, a timing circuit, a layout circuit, a proof reading circuit, a publishing circuit, a revenue circuit, a freebies circuit, an announcements circuit, a display circuit, a personals circuit, a job offerings circuit, a classifieds circuit, an offline distribution circuit, an interest based distribution circuit, a geo based distribution circuit, a profit share circuit and a syndication RSS circuit using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method comprising:
generating a geo-spatial environment in which residents are represented as users, and in which residents have associated meta-data indicating at least one of a physical location and an electronic location of the users;
processing a user selection of at least one of a submit a story idea indicator and a become a journalist indicator;
processing a submission form when the submit the story idea indicator is selected, and adding a submitted story idea that is geo-tagged to a location identifier of the user to an ideas database, and which remains in the ideas database for a threshold amount of time;
transforming a status of a different user to being a community journalist when the different user elects the become a journalist indicator; and
altering a status of the submitted story idea as being checked out when the community journalist selects the submitted story idea as being one which the community journalist chooses to author.

2. The method of claim 1 further comprising determining a timer for a duration of a checked out status of the submitted story idea, and resetting the timer when the community journalist authors an article based on the submitted story idea and submits the article to a journalism module.

3. The method of claim 2 further comprising automatically determining a continuing qualification of the community journalist based on responses to the timer, and at least one of a peer feedback rating and a reader feedback rating of the article authored by the community journalist.

4. The method of claim 3 further comprising providing a consideration to the community journalist in a form of at least one of a monetary award, a salary, and a recognition point based on at least one of the peer rating feedback, a number of reader page views, the reader feedback, and an advertising revenue generated based on geo-spatially targeted advertisements adjacent to at least one of the article and a community publication.

5. The method of claim 3 further comprising:
automatically generating a community publication based on the article and other articles submitted by other community journalists at a periodically occurring interval;
publishing a community publication in the geospatial environment to targeted users distributable to the electronic location of at least a subset of the targeted users subscribing to the community publication when the electronic location is available; and
creating a postal mailing of the community publication to another subset of the targeted users based on a mailing to the physical location of the targeted users, wherein the another subset of the targeted users have at least one of self declared a subscription to the community publication and which are targeted as being possibly interested in the community publication.

6. The method of claim 5 wherein the community publication is generated to a group based on at least one of a geographic location of the group, a common professional interests of the group, a religious affiliation of the group, a friendship between members of the group, an educational institution associated with the group, a cultural affiliation of the group, a political interest of the group, and a social interest of the group.

7. The method of claim 6 further comprising:
automatically generating the community publication in any of a selectable number of languages based on readership preferences of the members of the group and a moderator user who serves as an editor and publisher of the community publication in the geo-spatial environment;
embedding in the name of the community publication a name of an operator of the geo-spatial environment; and
automatically repositioning the article in an electronic version of the community publication based on a popularity of the article as elected by readers of the article in the electronic version of the community publication.

8. The method of claim 1 further comprising wherein the story idea is at least one of a personals listing data, a wedding announcement data, a classifieds advertisement data, a residential news data, a local sports data, a funnies data, a game data, a marketed property listing data, a crime statistics data, an events data, an obituary data, a polling data, a calendar data, a horoscopes data, and a freebees data.

9. The method of claim 8 wherein each reader of the community publication can vote on submitted story ideas for publication consideration in a future community publication based on a popularity of any particular submitted story idea with readers.

10. The method of claim 1 further comprising providing a mobile application to the community journalist to capture and record in video, audio, and text form an interview based on the submitted story idea, and to annotate text of the interview automatically in the mobile device.

11. The method of claim 10 wherein the mobile application is location aware based on a global positioning data provided in a mobile device embodying the mobile application and in which the community journalist does not have to indicate a current location of the journalist when navigating to a location of interest.

12. The method of claim 11 further comprising automatically generating a representation of neighbors and businesses surrounding a location of the community journalist and simultaneously providing access to a wiki data provided by users in locations surrounding and including the location of interest and a present location of the community journalist in a three-dimensional visual neighborhood view.

13. The method claim 1 in a form of a machine-readable medium embodying a set of instructions that, when executed by a machine, causes the machine to perform the method of claim 1.

14. A method comprising:
generating a set of story ideas which submitted by users of a geo-spatial social network and which are grouped based on a meta-data identifying at least one of a social, geographic, and interest based characteristic of the users which submit the set of story ideas;
allocating at least one of the story ideas to a different user who has elected to be a community journalist in the geo-spatial social network, and, in response to a article submission by the community journalist, automatically formatting and screening relevant content when approved by a community editor;
generating a community publication based on the relevant content submitted by the community journalist, other community journalists, and a user generated content data that includes an announcement data, a classifieds data, a user generated games data, and a personals data submitted by users who have joined a group which associates and subscribes them to the community publication;
distributing the community publication to subscribed individuals through a direct mail and an electronic communication based on a circulation criteria as defined by a moderator of the community publication in the geo-spatial environment.

15. The method of claim 14 further comprising providing a consideration to the community journalist in a form of at least one of a monetary award, a salary, and a recognition point based on at least one of the peer rating feedback, a number of reader page views, the reader feedback, and an advertising revenue generated based on geo-spatially targeted advertisements adjacent to at least one of the article and a community publication.

16. The method of claim 15 wherein each reader of the community publication can vote on submitted story ideas for publication consideration in a future community publication based on a popularity of any particular submitted story idea with readers.

17. The method of claim 16 further comprising providing a mobile application to the community journalist to capture and record in video, audio, and text form an interview based on a submitted story idea, and to annotate text of an interview automatically in the mobile device, and wherein the mobile application is location aware based on a global positioning data provided in a mobile device embodying the mobile application and in which the community journalist does not have to indicate a current location of the journalist when navigating to a location of interest.

18. A system, comprising:
a publishing module to create a user generated content having relevant news to a geo-spatially meta-tagged community at a predefined frequency;
a writing tools module to enable at least some of users of a geospatial environment to elect stories they wish to write articles on; and
a distribution module to automatically distribute to the user generated content to a members of a group associated with a target demographic associated with the user generated content by associating a meta-data associated with members of the group with a physical postal address and automatically generating a community publication to distribute to the group.

19. The system of claim 18 further comprising an ideas module to manage a set of user-generate ideas of a reader group of the community publication and to organize submitted ideas such that the submitted ideas conform to at least one of a predetermined set of templates which identify a structured data in which the ideas become submittable for consideration in a future community publication, and in which the predetermined templates include at least one of a news template, an announcement template, an obituary template, a sports template, a calendar template, a games template, a poll template, a crime data template, a real estate for sale template, and an advertising template, and a personals template.

20. The method of claim 18 further comprising a profit share module to allocate profits from revenues of classified and display advertisements in the community publication with authors of articles of the community publication, community journalists, an editor, idea submitters, and others who have submitted user generated content in the community publication to provide incentive providing future relevant and timely content in future community publications.
